(19) United States
(12) Patent Application Publication
(10) Pub. No.: US 2007/0023971 A1
(43) Pub. Date: Feb. 1, 2007

(54) Method of microwave processing ceramics and microwave hybrid heating system for same

(76) Inventors: Subrata Saha, Alfred, NY (US); Ram Mohan V.C., Bethesda, MD (US); Gary E. Delregno, Alfred, NY (US)

Correspondence Address: BURR & BROWN, PO BOX 7068, SYRACUSE, NY, 13261-7068, US

(21) Appl. No.: 10/570,940

(22) PCT Filed: Sep. 1, 2004
(86) PCT No.: PCT/US04/28331

§ 371 Date: Mar. 8, 2006

(51) Int. Cl. H05B 6/64; H05B 6/00; H05B 3/02

(52) U.S. Cl. 264/432; 264/434; 219/539

(57) ABSTRACT

A method for sintering ceramic materials using a microwave hybrid heating system includes the steps of providing a ceramic member to be sintered, providing a microwave furnace, providing a thermal containment box comprising a material that is virtually transparent to microwave energy, providing at least one susceptor comprising a material that directly couples to microwave energy at room temperature substantially immediately within the thermal containment box, positioning the ceramic member within the thermal containment chamber proximate the susceptor, and irradiating the thermal containment box with microwave energy. The susceptor couples to the microwave energy and generates heat within the thermal containment box and the temperature of the ceramic member increases to the microwave coupling-trigger temperature, at which time the ceramic member couples directly to the microwave energy and is directly sintered by the microwave energy in cooperation with radiant energy from the one susceptor.

### FIELD OF THE INVENTION

The present invention relates to a method for microwave processing of ceramic materials and a microwave hybrid heating system for microwave sintering ceramic materials. In particular, the present invention relates to a method of microwave sintering ceramic materials, including ceramic dental copings and porcelain dental coatings, using a microwave hybrid heating system on site at a Dentist's Office.

### BACKGROUND OF THE INVENTION

Dental ceramics can be classified as aesthetic ceramics or non-aesthetic ceramics. Aesthetic ceramics are used in the restoration of missing teeth or tooth structure (where natural smile is desirable), while non-aesthetic ceramics are used as dental implants, dental cements and biologically active ceramics. Aesthetic dental ceramics typically comprise feldspathic minerals, also referred to as dental porcelain, and glass-ceramic materials. Aesthetic dental ceramic materials are used extensively in the Dental Industry to make denture teeth, single-unit crowns, fixed partial dentures and labial veneers, for example. Other common uses of dental ceramics include full coverage crowns, inlays and onlays, porcelain bridges and veneering agents. These types of oral devices are generally classified under the category of Restorative Dentistry.

Restorative Dentistry is a branch of dentistry pertaining to oral rehabilitation, or the restoration and maintenance of oral functions, comfort, appearance and health of the patient by the restoration of natural teeth and/or the replacement of missing teeth and contiguous oral and maxillofacial tissues with artificial substitutes (adopted by the ADA on May 1976).

Crowns, also know as “caps,” are coverings that fit over teeth. As shown in FIG. 1, the crown or cap 100 fits over the supporting tooth structure 200 to give the overall appearance of an unaltered natural tooth. Crowns may be necessary because of damaged or worn out old fillings, fractured, chipped or sensitive teeth. Crowns can also be used to improve the appearance of natural teeth that are malpositioned, malformed or discolored. Crowns are typically composed of porcelain coating layers, which offer a natural look and which can improve the overall smile or simply blend with remaining teeth. An underlying metal or ceramic coping (also called a shell) is used under the porcelain layers. That is, dental porcelains are typically applied over a coping, such that the porcelain layers form the outer contour of the dental restorations that are in direct contact with the oral environment and any objects introduced therein, such as adjacent and opposing teeth, food, chewing gum, and the like.

A variety of different metal, ceramic and combination crowns are available, depending upon the particular oral rehabilitation situation, aesthetic and economical concerns of the patient.

“Full Cast Crowns” are basically all-metal crowns that are made from high noble or noble metals, generally all gold crowns. Full cast crowns offer excellent biocompatibility, are non-abrasive to opposing natural teeth, require the least damage to the underlying natural tooth (i.e., involve conservative tooth preparation), and are easily adjusted by the dentist both before and after cementation. Disadvantages associated with full cast crowns include the fact that metal teeth may not present an aesthetically pleasing appearance, and medically, some patients have may allergic reaction to the metals.

“Porcelain Fused to Metal Crowns” are basically a noble metal substructure or shell layered with dental glass ceramics to provide the desired aesthetic qualities. The advantages include excellent biocompatibility and a generally good color match with respect to the natural tooth that is capped as well as the surrounding natural teeth. Porcelain fused to metal crowns are also typically stronger than other types of crowns. There are some disadvantages associated with these types of crowns, however, including difficulty in adjusting the crown after cementation or placement and the risk that the crown may break due to the brittle nature of the aesthetic dental ceramic layers. Additionally, this type of crown typically requires involves a greater level of tooth preparation than full cast crowns, in that more of the vital tooth structure may be lost in preparation for providing and fitting the crown.

“All-Ceramic Crowns” consist of a ceramic core structure, made of, for example, zirconia or alumina that is then layered with dental glass ceramics. The advantages of all-ceramic crowns include a high level of aesthetic quality, excellent biocompatibility, and all-ceramic crowns can be bonded to the underlying prepared tooth structure for maximum retention. The minor disadvantages of all-ceramic crowns include a risk of breaking, and a greater degree of tooth reduction compared to fill cast crowns and porcelain fused to metal crowns. Additionally, the time required to prepare all-ceramic crowns in a dental lab is fairly extensive.

Recently, the trend in the dental industry has been focused toward metal-based crowns. However, in the face of emerging technologies related to dental materials, and also in view of dental patient demands for more aesthetic (non-metallic) teeth restoration options, restorative dentistry has undergone a dramatic change. With the increasing use of ceramic restorations, metallic restorations are slowly being phased out, and recently, the trend has swung toward the development of all-ceramic crown materials.

The properties that make ceramics ideal materials for restorative purposes include high compressive strength, dimensional stability, radiopacity and durability within the oral environment. Ceramics also imitate the aesthetic and optical properties of the natural teeth. The main disadvantages include low tensile strength, depending upon the material and processing conditions, vulnerability to stress corrosion, and shrinkage during processing. These factors, along with processing time considerations, impart design restrictions.

That is, the current state of manufacturing any type of exact fitting crowns requires elaborate, time-consuming procedures. Typically, the process involves multiple visits to the Dentist's office by the patient for tooth preparations, impressions, temporary crowns or restorations, and later, for the final application of the permanent crown. Meanwhile, the crowns are individually manufactured at an off-site dental lab, that is, not in-house at the Dentist's Office.

During the first appointment, the dentist reduces the target tooth uniformly so that the crown, which replaces the lost, damaged, or otherwise removed tooth structure, is not oversized (crowns must have a minimal thickness of 2 mm in order to have sufficient retention and strength). Subsequently, the tooth receiving the dental crown is slightly tapered in form so that the crown slips over the tooth and has a snug fit. Once the tooth preparation process is completed, the dentist casts an impression of the prepared tooth using an impression paste, which is a putty like material. These impressions are then sent to the dental lab along with the appropriate tooth shade that is esthetically acceptable to the patient.

In the meantime, the patient is provided with a temporary crown to protect the prepared tooth and to improve the patients comfort, ability to perform perfunctory oral operations, such as eating and drinking, and to compensate for aesthetics (i.e., fill a tooth gap or broken portion) until the permanent crown is ready. The time between the first visit and the final crown fitting and cementation can typically range from 10 days to two weeks.

After the dental lab receives the impressions from the dentist, dental technicians at the off-site dental lab use the impressions and pour, for example, Plaster of Paris (e.g., dental stone) to create a plaster cast of the tooth, which is a positive replica of the prepared tooth. “Die-pins” are attached to the plaster cast master model of the tooth requiring the crown. The die pins, along with the master model, are carefully examined for any defects. In the case of all-ceramic crowns, alumina or zirconia slip for the coping is applied over the master mold. Both the mold and the coping are then placed in a conventional sintering oven.

The ceramic coping and the mold are then sintered at a temperature of approximately 1450° C. Sintering in a conventional sintering oven typically requires 8 to 12 or even more hours, and may vary significantly between different dental lab facilities. During this firing cycle, the alumina or zirconia cast coping remains retains the cast shape and size while the mold shrinks. This provides a coping that fits snugly to the master die before firing (which represents the actual tooth onto which the crown will later be fit).

In order to achieve the desired aesthetics, that is, the required tooth shade, the dental technician then applies the desired shade of infiltration glass and fires it. The glass flows between the alumina or zirconia particles and fills the spaces therebetween. This process of infiltration also strengthens the copings. The alumina or zirconia copings are then sandblasted to prepare a proper bonding surface structure in preparation for the application of the porcelain shades. The above steps generally require around 14 hours to fully prepare an infiltrated coping suitable for dental porcelain application.

There are generally four basic shades that are applied to obtain a natural looking ceramic tooth. An opaque base, which is a combination of body porcelain and opaque porcelain in suitable proportions, is first used to mask the underlying copings. A dentine shade is then applied, which gives the crown a warm glow imitating the natural dentine. Applying these shades prevents the restoration from having an unnaturally opaque look. Two ample coats of dentine shades over the opaque shade will promote natural appearing aesthetics in the ceramic dental restorations. An enamel shade is applied to lend more depth and natural color to the restoration. The enamel shade mimics the natural tooth enamel in appearance. Finally, a glaze layer is applied. This layer imparts an overall esthetically pleasing look to the completed restorations and also contributes extra strength to the porcelain restorations. Glaze powders are mixed and manipulated using a dental modeling liquid in order to achieve the proper consistency.

As a rule of a thumb, the first layer of opaque base is usually baked in a furnace at temperatures of about 860° C. to 900° C. and at a holding time of about three to five minutes. The same heat treatment procedure is then repeated after the application of each subsequent layer. The whole cycle usually takes approximately 2-3 hours, but may take even longer if the dental technician decides to fire and cool the crown using a slower ramp rate. The crowns are polished using slow speed diamond burs and then finished using a polishing paste.

Once the dental lab is completely satisfied with the finished crown, it is sent back to the Dentist to be inserted into the patient's mouth. That is, days, or even weeks from the initial time when the patient first underwent the necessary tooth preparation, the patient returns to the dental office, the temporary crown is removed, and the permanent crown is installed on the prepared tooth with any standard dental cement pertaining to crowns.

Other processes for producing full cast crowns and porcelain fused to metal crowns include the lost wax technique and the use of CAD/CAM modeling systems, which are known to those in the dental industry. Still, the copings, whether metal or ceramic, must be sintered in order to impart the desired structural, performance and aesthetic characteristics to the final restoration. While conventional sintering processes can provide the desired characteristics, the times required to do so are extensive and the entire process is labor intensive, from the steps performed at the dentist's office to the processes performed at the dental lab and back to the dentist again.

For example, as mentioned above with respect to all-ceramic crowns, the duration of time between the initial delivery of the impression to the dental lab and production of the final sintered crown takes approximately ten to fourteen days. Again, this time span may vary between different dental labs. While the sintering or firing cycle of the ceramic coping plays a vital role in making an all-ceramic crown, sintering ceramic copings, and particularly zirconia copings, and the subsequent sintering of the dental glass ceramic itself requires a great deal of time. This, in turn, has promulgated the need for a faster sintering process which is reliably reproducible and which reduces the manufacturing time without compromising the mechanical and the aesthetic properties of the dental restorations that can be presently achieved with conventionally sintered dental crowns.

Zirconia has long been a preferred biomaterial for many reasons, and is particularly suitable for dental ceramic applications. Zirconia (zirconium oxide, ZrO₂) is a highly stable oxide ceramic that is typically used in industrial applications requiring high strength, resistance to chemicals and stability. One factor that makes stabilized zirconia materials desirable for dental applications is its excellent ability to hinder the progress of cracks, and the process of transformation toughening or strengthening is the key virtue of this material.

The physical and mechanical properties of zirconia include a density of 6.1 g/cc, a Vickers Hardness (V) of 1200, flexural strength greater than 900 MPa, a modulus of elasticity of 210 GPa, a coefficient of thermal expansion (CTE) of 8-10×10⁻⁶ in/in/K for temperatures between 25 and 500° C., a fracture toughness of 9 MPa·m^{0.5} and a corrosion resistance less than 10×10⁻⁶ g/cm². Additionally, the mechanical properties of densely sintered zirconia exceed the known values of those of many conventionally known dental ceramic materials and actual natural tooth structures.

For example, zirconia typically exhibits a bending strength on the order of 900 MPa, whereas the bending strength of a glass-infiltrated slip cast alumina (e.g., In-Ceram alumina) is 419 MPa and that of industrially fabricated glass-infiltrated alumina (e.g., Vita-Celay alumina) is 547 MPa. Leucite reinforced porcelain, such as IPS Empress, exhibits a known bending strength of 182 MPa and Omega feldspathic porcelain tested at 85 MPa Natural tooth structures have comparably low bending strengths, on the order of 65-75 MPa for enamel and 16-20 MPa for dentine.

While zirconia exhibits a toughness of about 9 MPa·m^{0.5}, In-Ceram alumina has a toughness of about 2.4-5 MPa·m^{0.5} and the tested toughness of Vita-Celay alumina is about 3.55 MPa·m^{0.5}. IPS Empress has a toughness of 1.77 MPa·m^{0.5}. Even natural tooth structures have a higher toughness than Omega feldspathic porcelain (0.99 MPa·m^{0.5}), with natural enamel having a toughness of 1 MPa·m^{0.5} and natural dentine having a toughness of 2.5 MPa·m^{0.5}.

Transformation toughening is a mechanism whereby through the appropriate use of additives such as yttrium oxide, zirconia particles can be stabilized with a tetragonal crystal structure at room temperature. Tetragonal crystal structures impart maximum strength to this ceramic material. Hence, when an external energy source, such as a stress at a crack tip, is applied to toughened zirconia, it goes through an instantaneous phase transformation to a monoclinic structure. There is a 4% increase in volume at the vicinity of the crack tip, however, the surrounding material remains in the tetragonal phase and exerts compressive forces on the monoclinic structure in the crack vicinity, which essentially clamps the cracks shut and restricts further crack propagation. Also, along with the increase in volume is an absorption of energy, which also prevents further crack propagation. This mechanism is of utmost importance in oral environments that feature low-level repetitive stresses (fatigue situations) and high moisture. Thus, zirconia materials impart excellent toughness and are a superior choice for reliable restorations in restorative dentistry when compared to other potential dental restoration materials.

There are some limitations, however, associated with using zirconia as a dental ceramic for restorations. For example, the processing parameters (e.g., sintering time and temperature) required to achieve complete sintering of the desired final dental restoration product can be disadvantageous when using conventionally implemented firing methods.

Microwave energy offers a fast and effective sintering process that can reduce processing time by as much as 90% and which offers energy savings as a result. These decreased processing times and energy savings associated with microwave sintering, however, can only be applied to materials that can be readily processed by microwaves. That is, many ceramic materials, such as SiO₂, Al₂O₃ and ZrO₂ are transparent to microwaves at room temperature, i.e., do not substantially reflect or absorb microwaves. As such, these materials do not couple directly with microwaves at room temperature because they have a low dielectric loss factor.

Limited mention has been made of sintering dental materials using microwaves. For example, U.S. Pat. No. 5,475,912 to Sundström discloses a method of forming a crown wherein an impression of the prepared tooth surface is made from soft aluminum metal foil which is subsequently converted to hard and heat-resistant alpha-corundum by electrochemical methods. The corundum foil can then be used as a base for building a ceramic crown or onlay. Since the same foil that was used to make the original impression becomes part of the crown or onlay, many copying operations are avoided and the precision is retained. After being converted, the oxide foil is fired at a temperature over 700° C., preferably around 900° C., whereby the oxide recrystallizes to a waterless alpha-corundum with unchanged dimensions. The firing can be made in a conventional muffle oven or with microwave heating. The '912 suggests that microwave heating provides faster and smoother heating concentrated to those parts where some moisture is left, but there is no disclosure or suggestion in the '912 patent as to the specific steps, such as firing parameters, or as to the particular structure of the microwave furnace system itself.

U.S. Pat. No. 6,325,839 to Prasad et al. discloses microwave sintering metal-based dental restoration materials. According to the '839 patent, higher heating rates may be achieved using microwave energy, which reduces the time necessary for sintering the metal-based materials. The '839 patent suggests that is possible to produce high strength metal-based dental restorations at lower temperatures having high hardness and density and small grain size using microwave energy.

The '839 patent teaches that the metal powder is preferably a high fusing metal and may comprise one or more precious metals, non-precious metals and alloys thereof, and that preferably, the metal powder comprises a non-oxidizing metal. The metal powder is mixed with a binder, and optionally a solvent, each of which are driven off during sintering. Alternately, the metal may be in the form of a thin metal foil containing one or more of gold, platinum, silver and alloys thereof.

After the metal material has been formed, i.e., modeled onto the die, molded to the desired form or inserted into a mold, the model created is ready for firing. The model is sintered in a microwave apparatus which is similar to a conventional porcelain oven, but which supplies microwave energy to sinter the materials placed therein. The sintering temperature range depends upon the metal or alloy being used, and the sintering temperature is preferably below, but near the melting temperature of the metal/alloy. Typically, the sintering range is about 800° C. to about 1200° C. The sintering time varies depending on the cross-sectional area of the restoration, for example, a dental crown having a very thin cross-section will take less time than a pontic or bridge with a thicker cross-section. While the '839 patent suggests that the sintering time could be as low as about one minute to ten or twenty minutes or as high as one to two hours, there is no disclosure or suggestion in the '839 patent of how to actually achieve such rapid sintering times.

The '839 patent also discloses that the sintered metal layer is coated with a ceramic or porcelain material and thereafter sintered in a microwave apparatus or in a conventional porcelain oven to obtain a dental restoration. At most, however, the '839 patent merely suggests that microwave sintering can be used to produce metal and metal coated dental restorations. That is, there is no disclosure therein of any specific processing parameters or particulars of the MHH system required to sufficiently microwave sinter one or a plurality of such metal or coated metal dental restorations.

Dental material researchers agree that new technology permits faster sintering of complex ceramic shapes while maintaining an exact fit and would considerably reduce the manufacturing costs, and would thus be desirable. Further, it would be desirable to be able to sinter many ceramic crowns or restorations simultaneously and to deliver the crowns in a shorter period of time. This particular aspect is of utmost importance in dental treatment protocol. It has been widely held in the dental industry, however, that before a dentist or a dental technician will accept and implement new processing technologies, the ability to sinter many crowns or restorations in less time will be imperative.

Thus, it would be desirable to provide a method for processing ceramic dental restorations using microwave hybrid heating that significantly reduces the sintering times required to produce dental ceramic restorations that have physical, mechanical and microstructural characteristics that are comparable to, if not superior to, conventionally fired samples. It would also be desirable to provide a microwave hybrid heating system to facilitate such microwave sintering of ceramic materials and that allows an operator to reliably and reproducibly control the firing parameters and thus ensure repeatable and consistent results with respect to the desired properties of dental restorations processed by the system. It would also be desirable to provide a method for producing dental ceramic restorations using the microwave hybrid heating system quickly and easily on-site in the dentist's own office during a single patient visit, rather than sending the work to an off-site dental laboratory facility.

### SUMMARY OF THE INVENTION

It is an object of the present invention to overcome the problems described above. That is, it is an object of the present invention to provide a method for processing ceramic materials, and in particular, ceramic dental restorations, using a microwave hybrid heating system that significantly reduces the sintering times required to produce sintered ceramic members that have physical, mechanical and microstructural characteristics that are comparable to, if not superior to, those of conventionally sintered ceramic members. It is an object of the present invention to provide a method for producing dental ceramic restorations using the microwave hybrid heating system on-site in the dentist's own office during a single patient visit, rather than sending the work to an off-site dental laboratory facility.

In view of the above objects, a method for sintering ceramic materials at a sintering temperature greater than room temperature is provided according to one embodiment of the present invention. The method includes the steps of providing a ceramic member to be sintered, wherein the ceramic member comprises a material that does not substantially reflect microwave energy at room temperature and that does not substantially couple to microwave energy until the ceramic material is heated to a microwave coupling-trigger temperature. The method also includes a step of providing a microwave furnace having a magnetron microwave source and a microwave chamber lined with a reflective material and a step of providing a thermal containment box having an inner surface and an outer surface defining a thermal containment chamber. The thermal containment box comprises an insulative material that does not substantially absorb or reflect microwave energy at any temperature lower than a maximum sintering temperature of the ceramic member to be sintered and which has a melting temperature that is greater than a maximum sintering temperature of the ceramic member to be sintered. The method further includes the steps of providing at least one susceptor within the thermal containment chamber, wherein the at least one susceptor comprises a material that directly couples to microwave energy at room temperature substantially immediately, positioning the ceramic member within the thermal containment chamber proximate the susceptor, positioning the thermal containment box within the microwave chamber of the microwave furnace and irradiating the microwave chamber with microwave energy from the magnetron source. The susceptor substantially immediately couples to the microwave energy. Heat is generated by the susceptor and radiated therefrom to heat the thermal containment chamber and the ceramic member positioned therein. The temperature of the ceramic member increases, in response to the radiant heat emitted from the susceptor, to the coupling-trigger temperature of the ceramic member, whereby the ceramic member couples directly to the microwave energy. The method also includes a step of directly sintering the ceramic member with the microwave energy in cooperation with the radiant energy emitted from the susceptor.

According to one embodiment of the present invention, the susceptor has a microwave reflecting temperature that is greater than or substantially equal to the coupling-trigger temperature of the ceramic member. In that manner, the ceramic member is heated at least to its microwave coupling-trigger temperature by the radiant heat from the susceptor so that the ceramic member directly couples to the microwave energy before the susceptor reaches the temperature at which it becomes reflective to the microwave energy and ceases to absorb the microwaves and emit radiant heat.

According to one embodiment of the present invention, the susceptor comprises SiC and the ceramic member comprises zirconia stabilized with 3 mol % yttria.

According to a preferred embodiment of the present invention, the susceptor comprises at least one primary susceptor and at least one secondary susceptor. It is preferred that each primary susceptor and each secondary susceptor each has a melting temperature that is greater than a maximum sintering temperature of the ceramic member, and the secondary susceptor preferably has a microwave coupling-trigger temperature that is higher than room temperature and lower than the microwave reflecting temperature of the primary susceptor. It is also preferred that the microwave reflecting temperature of the secondary susceptor is greater than the coupling-trigger temperature of the ceramic member. In that manner, the ceramic member is sintered by directly coupling to the microwave energy in cooperation with the radiant heat emitted from the secondary susceptor.

According to one embodiment, the primary susceptor comprises SiC and the secondary susceptor comprises reticulated zirconia

According to another embodiment, the ceramic members comprise a dental ceramic material, preferably a Y-TZP (yttria tetragonal zirconia polycrystal) ceramic. According to yet another embodiment, the ceramic members comprise a sintered dental ceramic material that is coated with one or more layers of a dental enamel material or a glass-ceramic material.

According to another aspect of the present invention, a microwave hybrid heating system for sintering one or more ceramic members having a microwave coupling-trigger temperature that is greater than room temperature is provided. The microwave hybrid heating system includes a microwave furnace having a magnetron microwave source and a microwave chamber lined with a reflective material, and a thermal containment box having an inner surface and an outer surface defining a thermal containment chamber. The thermal containment box comprises an insulative material that does not substantially absorb or reflect microwave energy at any temperature less than or substantially equal to a maximum sintering temperature of the ceramic member to be sintered, and has a melting temperature that is greater than the maximum sintering temperature of the ceramic member to be sintered. The microwave hybrid heating system also includes at least one susceptor positioned within the thermal containment chamber. The susceptor comprises a material that directly couples to microwave energy at room temperature substantially immediately. The ceramic members to be sintered are positioned within the thermal containment chamber and the thermal containment box is positioned within the microwave chamber. When microwave energy from the magnetron source irradiates the thermal containment box within the microwave chamber, the susceptor substantially immediately couples to the microwave energy to generate heat. The heat from the susceptor radiates therefrom to heat the thermal containment chamber and the one or more ceramic members positioned therein. The temperature of the ceramic members increases to the microwave coupling-trigger temperature, whereby the ceramic members couple directly to the microwave energy and the ceramic members are sintered by the microwave energy in cooperation with the radiant energy emitted from the susceptor.

### BRIEF DESCRIPTION OF THE DRAWINGS

For a better understanding of the nature and objects of the present invention, reference should be made to the following drawings, in which:

FIG. 1 is a schematic illustration showing a dental restoration (i.e., crown or cap) positioned on a supporting tooth structure;

FIG. 2 is a partial cross-sectional view of a microwave hybrid heating system according to one embodiment of the present invention;

FIG. 3 is a partial cross-sectional view of a MHH system according to another embodiment of the present invention;

FIG. 4 is a flow chart showing a method for microwave sintering a green ceramic member according to one embodiment of the present invention;

FIG. 5 is a flow chart showing a method for microwave sintering a coated ceramic member according to one embodiment of the present invention;

FIG. 6 is an experimental time-temperature sintering profile for zirconia copings sintered in a conventional furnace at a ramp rate of 10° C. per minute to 1450° C.;

FIG. 7 is an experimental time-temperature sintering profile for zirconia coping samples conventionally fast-fired at a ramp rate of 40° C. per minute to 1400° C.;

FIG. 8 is an experimental time-temperature sintering profile for microwave-sintered zirconia copings from microwave sintering Runs A-E;

FIG. 9 is an experimental time-temperature sintering profile for microwave-sintered zirconia copings from microwave sintering Run A;

FIG. 10 is an experimental time-temperature sintering profile for microwave-sintered zirconia copings from microwave sintering Run B;

FIG. 11 is an experimental time-temperature sintering profile for microwave-sintered zirconia copings from microwave sintering Run C;

FIG. 12 is an experimental time-temperature sintering profile for microwave-sintered zirconia copings from microwave sintering Run D;

FIG. 13 is an experimental time-temperature sintering profile for microwave-sintered zirconia copings from microwave sintering Run E;

FIG. 14 is an experimental time-temperature sintering profile for microwave-sintered zirconia copings from microwave sintering Run F including a dwell time of 20 minutes;

FIG. 15 is a chart showing the relationship between percentage density and sintering temperature for microwave-sintered samples from Runs A-E and conventionally sintered samples fired at 1450° C. with a ramp rate of 10° C. per minute;

FIG. 16 is a chart showing the relationship between Vickers Hardness Number (VHN) and the percentage density for microwave-sintered samples from microwave sintering Runs A-E and conventionally sintered samples fired at 1450° C. at a ramp rate of 10° C. per minute;

FIG. 17 is a chart showing the relationship between the indentation fracture toughness under 20 Kg load testing and sintering temperature for microwave-sintered samples from microwave sintering Runs A-E and conventionally sintered samples fired at 1450° C. at a ramp rate of 10° C. per minute;

FIG. 18 is a chart showing the relationship between the indentation fracture toughness under 30 Kg load testing and sintering temperature for microwave-sintered samples from microwave sintering Runs B-E and conventionally sintered samples fired at 1450° C. at a ramp rate of 10° C. per minute;

FIG. 19 is an experimental time-temperature sintering profile for coated zirconia copings that were microwave sintered at 800° C. with a 10 minute preheat period, a ramp rate exceeding 270° C. per minute between 200° C. and 800° C. and a one minute dwell time;

FIG. 20 is an experimental time-temperature sintering profile for the coated zirconia coping that was microwave sintered at 700° C. with a dwell time of one minute;

FIG. 21 is an experimental time-temperature sintering profile for the coated zirconia copings that were microwave sintered under “rapid power” without a preheat period from room temperature to 800° C. with a one minute dwell time at 800° C.;

FIG. 22 is an experimental time-temperature sintering profile for coated zirconia copings that were microwave sintered to a temperature exceeding 800° C. with no dwell time;

FIG. 23 is an experimental time-temperature sintering profile for a plurality of microwave-sintered coated zirconia coping samples that were simultaneously microwave sintered to a temperature of about 800° C. with a dwell time of one minute;

FIG. 24 is a chart showing a comparison of the Vickers Hardness Numbers for microwave-sintered and conventionally sintered coated zirconia coping samples;

FIG. 25 is an X-ray diffraction pattern for a sample of the opaque base shape powder;

FIG. 26 is an X-ray diffraction pattern for a sample of the luster shade powder; and

FIG. 27 is an X-ray diffraction pattern for a microwave-sintered, coated zirconia coping sample.

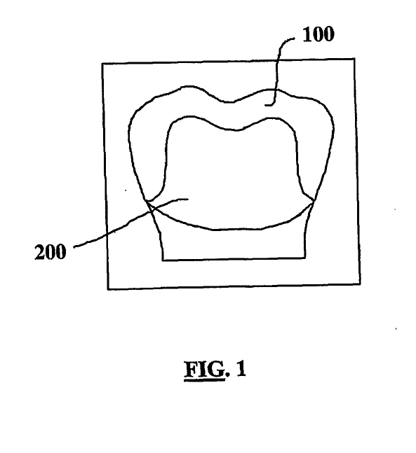

### DETAILED DESCRIPTION OF THE INVENTION

The present invention provides a microwave hybrid heating system and methods for microwave sintering ceramic materials in a fraction of the time required to conventionally sinter the same materials. The ceramic materials that are sintered in the microwave hybrid heating system according to the present invention and using the method according to the present invention have physical, aesthetic and mechanical properties that are comparable to, if not superior to, the properties achieved in conventional firing processes. It should be noted, however, that while the specific examples included herein involve dental copings made of zirconia stabilized with 3 mol% yttria (Y-TZP, yttria tetragonal zirconia polycrystal) that are used for crown-type dental restorations, the present invention is not limited to the specific examples set forth below.

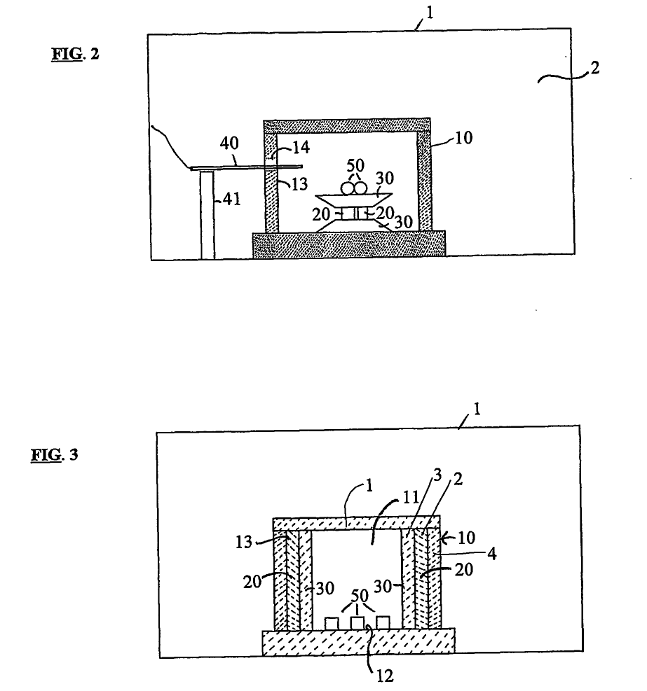

FIG. 2 is a partial cross-sectional view of a microwave hybrid heating (MHH) system according to one embodiment of the present invention. The MHH system includes a standard microwave furnace 1 that operates at a frequency of 2.45 GHz, including a magnetron microwave source. The MHH system also includes a thermal containment box 10, which is made from a material that is transparent to microwaves, even at high temperatures. That is, the material of the thermal containment box 10 preferably does not absorb or reflect microwave energy at any temperature less than or substantially equal to the maximum sintering temperature of the ceramic samples 50 to be sintered therein. The particular material of the thermal containment box 10 is not critical, so long as it can withstand the sintering temperatures and contain the heat generated by the interaction of the microwaves with the materials provided in the thermal containment chamber 11 thereof Examples of suitable materials include, but are not limited to, fibrous alumina, foam silica, and boron nitride.

The insulative properties of the thermal containment box 10 also contribute to the overall energy efficiency of the MHH system according to the present invention, as described in more detail below. The thermal containment box can have any shape, such as a cube, rectangle, or cylinder, for example, and the specific size and shape of the thermal containment box is not restricted, except by practical considerations, such as the size and shape of the microwave chamber.

The MHH system according to the present invention also includes a plurality of primary susceptors 20 made from a material such as SiC that readily couples to microwave energy at room temperature. Examples of suitable materials also include, but are not limited to, molybdenum disilicide (MoSi₂), graphite, and other high dielectric loss ferrite-type materials. The primary susceptors 20 can be any shape, such as annular, disk or plate-shaped, and the particular size and shape of the primary susceptors 20 is not restricted.

If the temperature at which the material of the primary susceptors 20 tends to become reflective to microwave energy (hereinafter referred to as the microwave reflecting temperature) is less than the maximum sintering temperature of the samples, it is also preferred to include a plurality of secondary susceptors 30, as well. The secondary susceptors 30 can be made of any material that can withstand the sintering temperatures within the thermal containment chamber 11 and which couples to microwaves at a temperature (hereinafter referred to as the microwave coupling-trigger temperature) that is greater than room temperature and less than the microwave reflecting temperature of the primary susceptors 20.

Along those lines, if a gap exists between the microwave reflecting temperature for the primary susceptor 20 and the coupling-trigger temperature of the secondary susceptor 30, it is also possible to provide one or more intermediate susceptors having a stacked and overlapping dielectric loss configuration. The microwave coupling-trigger temperature of each intermediate susceptor is preferably less than the microwave reflecting temperature for the primary susceptor and any preceding susceptors. Likewise, the microwave reflecting temperature of each intermediate susceptor is preferably greater than the microwave coupling-trigger temperature for the successive susceptors. It is also preferred that at least one susceptor has a microwave reflecting temperature that is greater than the microwave coupling-trigger temperature and the maximum sintering temperature of the ceramic material 50 to be sintered, so the ceramic material gains the benefit of radiant heat from a susceptor in cooperation with direct microwave sintering.

For example, the MHH system shown in FIG. 2, which was also used in the experiments described below, includes a plurality of ring-shaped SiC (silicon carbide) susceptors 20 that are provided as primary susceptors, and two reticulated zirconia plates 30 provided as secondary susceptors. The reticulated zirconia plates 30 are positioned on the floor 12 within the containment chamber 11 of the alumina thermal containment box 10, and the SiC susceptors 20 are sandwiched between the reticulated zirconia plates 30. As shown, the thermal containment box 10 is positioned within the microwave cavity 2 of the microwave furnace 1. The thermal containment box 10 includes at least one port 14 through which a thermocouple 40 is inserted to monitor the temperature within the thermal containment chamber 11. As shown, the thermocouple 40 is supported by a metallic pedestal 41, however, any means for supporting and positioning the thermocouple can be used. In addition, an optical pyrometer can be used in lieu of a thermocouple. It should be noted, however, that means for monitoring the temperature within the thermal containment chamber is not limited to the specific examples shown and described herein.

Thus, according to the embodiment of the MHH system of the present invention shown in FIG. 2, the silicon carbide primary susceptors 20 directly couple to the microwave energy at room temperature substantially immediately and become infrared radiant heaters. The reticulated zirconia plates 30 absorb the infrared heat energy from the SiC rings 20 and further increase the temperature within the containment chamber 11 by radiating heat and acting as secondary susceptors. In that manner, the reticulated zirconia plates 30 continue to provide radiant heat to the system even after the temperature exceeds the microwave reflecting temperature of the SiC primary susceptors 20. The ceramic samples 50 are initially heated by the radiant energy emitted from the SiC primary susceptors 20 and then by the radiant energy emitted from the reticulated ZrO₂ secondary susceptors 30 until the microwave coupling-trigger temperature for the ceramic samples 50 is reached. At that point, the ceramic samples 50 directly couple to the microwave radiation for the duration of the sintering process and also gain the benefit of improved heating uniformity that is provided by the cooperative radiant heat emitted from the secondary susceptors 30.

It is not necessary to provide secondary or intermediate susceptors, however, so long as the primary susceptors comprise a material which has a microwave reflective temperature that is greater than the microwave coupling-trigger temperature of the ceramic samples 50. That is, while the radiant heat emitted from the susceptors cooperates with the microwave energy to provide uniform heating during sintering, even after the sample material begins to directly absorb the microwave energy itself, the external radiant heat is not required in order for the sample to realize the above-described benefits of microwave sintering.

As mentioned above, the insulative properties of the thermal containment box 10 contribute to the overall energy efficiency of the MHH system according to the present invention. Unlike conventional sintering furnaces, the energy required to heat the MHH system is well contained within the thermal containment chamber 11 and not lost. In that manner, the overall energy efficiency of the system is improved over conventional systems. More specifically, the thermal energy generated by the susceptors 20, 30 is contained within the containment box 10 and, as such, is not dissipated away from the ceramic samples 50 to be sintered. The sample temperature can be quickly raised to the microwave coupling-trigger temperature by virtue of the radiant heat generated by the susceptors 20, 30, which is effectively concentrated in the thermal containment chamber 11, instead of by continually increasing the amount of energy required to heat and maintain heat within the system.

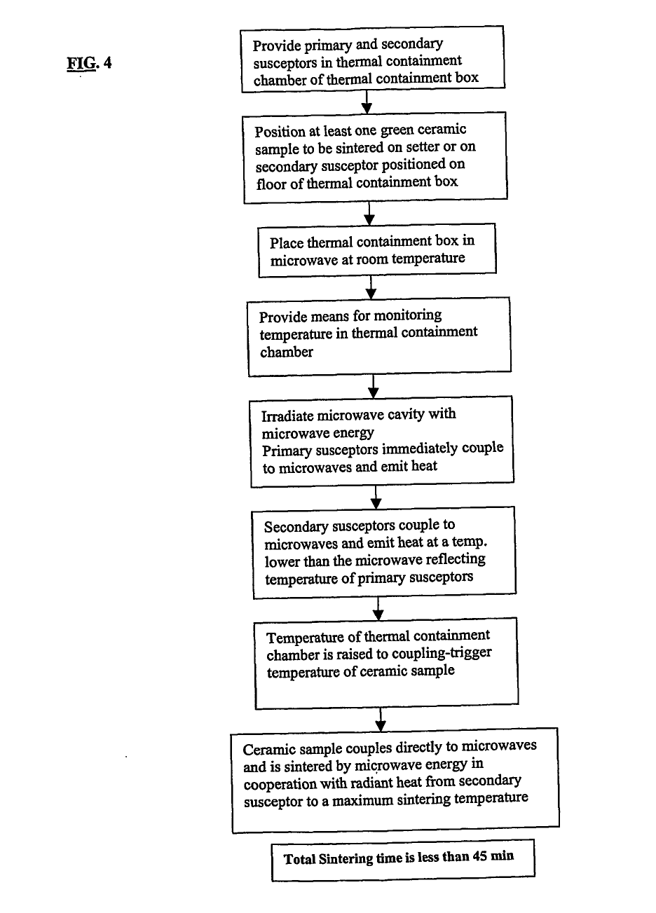

FIG. 3 is a partial cross-sectional view of another MHH system according to the present invention. Like components have been designated with like reference numbers, which are described above with reference to FIG. 2. The embodiments shown in FIGS. 2 and 3 primarily differ with respect to the configurations of the primary susceptor 20 and secondary susceptor 30.

As shown in FIG. 3, a primary susceptor 20, made of SiC for example, is provided as a layer positioned on the inner peripheral surface 13 of the thermal containment chamber 11. A secondary susceptor 30, such as reticulated ZrO₂, is provided as a layer positioned on and covering the primary susceptor 20. In that manner, the inner peripheral sides of the thermal containment chamber 11 are substantially covered by the susceptor configuration, and the primary susceptor 20 is sandwiched between the inner peripheral wall 13 of the thermal containment chamber 11 and the secondary susceptor 30. It should be noted, however, that this configuration is not limited to the embodiments shown in FIGS. 2 and 3 wherein the thermal containment box 10 is substantially cylindrical, and modifications can be easily made to accommodate other shapes.

As mentioned above, the particular configurations of the susceptors 20, 30 are not limited to the embodiments shown herein. That is, the shapes, sizes and positions of the primary 20 and secondary 30 susceptors, are selected based on the mass of the load, the size of the thermal containment box, and the dielectric properties of the particular susceptor materials.

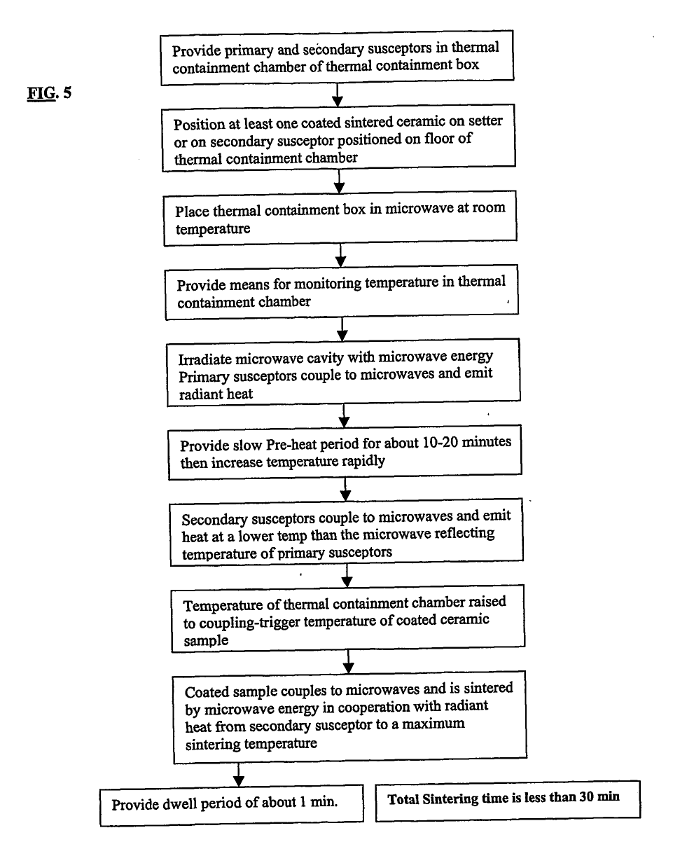

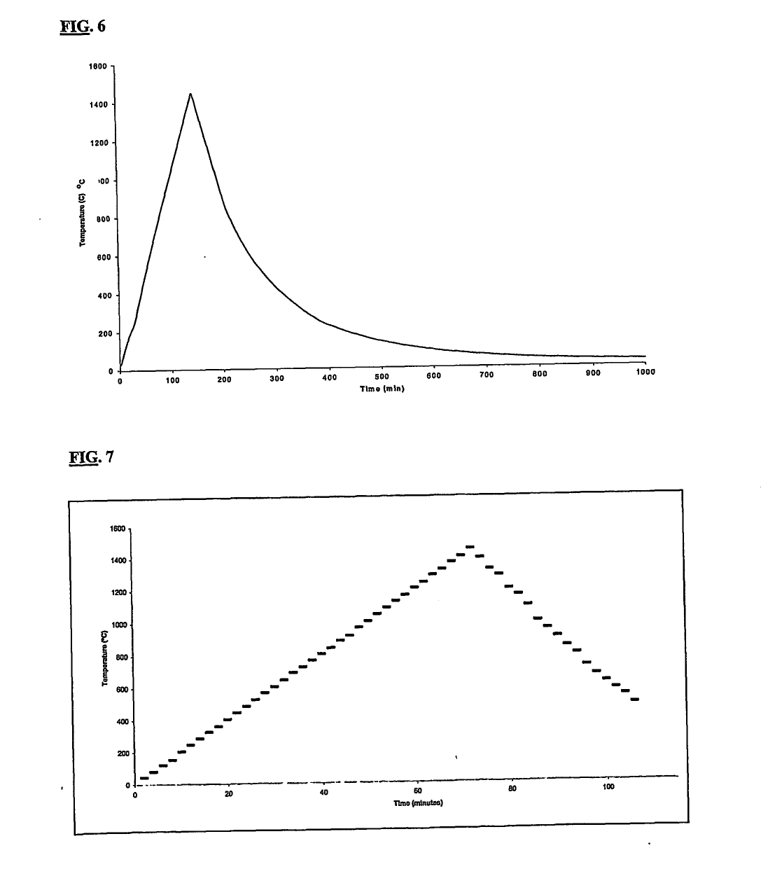

FIG. 4 is a flow chart showing a method for microwave sintering green ceramic members according to one embodiment of the present invention. At room temperature, at least one green ceramic sample is positioned on a setter, or directly on a secondary susceptor such as a reticulated zirconia plate, proximate the floor of a thermal containment chamber of a thermal containment box. The thermal containment box is positioned within a microwave cavity of a microwave furnace and means for measuring the temperature within the thermal containment chamber is provided, such as a thermocouple or optical pyrometer. A steep heating rate, preferably greater than 50° C./minute, is employed to achieve a maximum sintering temperature. The time required to complete firing is preferably less than 45 minutes, and is more preferably in a range of 29-39 minutes, depending on the maximum desired sintering temperature and the overall mass of the green ceramic members to be sintered. The properties of the ceramic sintered according to this method are comparable to those achieved by conventionally sintering the samples at a slow ramp rate to a maximum temperature that is within 150° C. of the maximum microwave sintering temperature.

According to another embodiment of the present invention, a method is provided for microwave sintering ceramic materials, such as zirconia dental copings, that have been previously sintered and then subsequently coated with one or more layers of a ceramic enamel or a glass-ceramic type composition. As shown in FIG. 4, the method includes the steps of placing the coated sintered ceramic sample in the thermal containment chamber of the thermal containment box of the MHH system at room temperature in the same manner described above with respect to FIG. 3. An initial pre-heat period is provided, the duration of which varies depending upon the mass of the samples to be sintered and during which time the temperature within the thermal containment chamber is gradually raised by the radiant heat emitted from the primary susceptors. The thermal containment chamber is then heated at a steep rate, preferably exceeding 150° C./minute, to the desired maximum sintering temperature of the coated ceramic sample, which is preferably about 800° C. for the specific examples described herein. At the maximum sintering temperature, a dwell period of about 1 minute is preferably provided. The time required to reach the maximum sintering temperature according to the method shown in FIG. 4 is preferably less than 30 minutes, and more preferably, in a range of about 14-24 minutes, depending upon the mass of the samples and the pre-heat period provided, with a major portion of this time being provided for the pre-heat period.

The following experiments detail the practical applicability of the MMH systems and microwave sintering methods of the present invention to Y-TZP-based ceramic dental restorations, wherein stabilized zirconia copings and enameled Y-TZP crowns were produced using a MHH system and methods according to the present invention. The experiments detailed below show that these microwave-sintered samples exhibit properties that are comparable to, if not superior to, those of conventionally fired stabilized zirconia copings and coated zirconia crowns. Moreover, the sintering times achieved using the MHH system and the methods of the present invention represent a fraction of the time required in conventional sintering systems and processes.

### Experiment 1

### Microwave Sintered vs. Conventionally Sintering for Zirconia Dental Ceramics

Zirconia cylinders stabilized with 3 mol % yttria, which are analogous to dental copings, were sintered in the microwave furnaces at various temperatures and compared with conventionally sintered samples that were fired at 1450° C. The properties of the microwave-sintered samples that were fired at a higher ramp rate were compared to the relatively slow ramp rate used in conventional sintering. The density, hardness and indentation fracture toughness of the samples that were microwave-sintered at temperatures of 1400° C. and 1450° C. compared well with the conventionally sintered samples. The average microstructure of the microwave-sintered samples had less voids, more uniform grain size distribution than that of the conventionally sintered samples owing to volumetric heating phenomenon.

Sample Preparation:

Zirconia stabilized with 3 mol % yttria (TOSOH, Japan) powder was uniaxially pressed (compacted) into cylinders measuring 8.36±0.89 mm by 5.33±0.34 mm and weighing 0.58 g at a pressure of 2000 psi using a standard Carver hydraulic piston press and commercial tool steel die. The samples were cleaned, numbered and vacuum sealed in polyethylene bags. Care was taken to properly evacuate the air from the bag. The samples were then cold isostatically pressed at 15000 psi to assure maximum particle density and green strength. Traces of oleic acid were cleaned from the samples with Kimwipe® tissues, and the samples were then rebagged and numbered accordingly.

Seventy four cylinders were prepared by this method. Ten misshapen cylinders were discarded. Thirty samples were utilized for conventional sintering. The remaining thirty four were sintered with the microwave furnace. Each sample was weighed and the dimensional lengths and diameters were measured with a micrometer (Mitutoyo, Japan).

Sintering in the Conventional Furnace:

30 samples, six at a time, were conventionally sintered in a Thermolyne 5000 series tube furnace. The Thermolyne 5000 furnace was equipped with time and temperature profile rate recording capability. The furnace was heated at a rate of approximately 10° C. per minute to a maximum sintering temperature of 1450° C. An additional lot of pellets measuring 2.5 mm by 0.4 mm and weighing 6 g were prepared as described above, as well, and sintered in a Linderberg conventional furnace at a rate of approximately 40° C. per minute in order to study the effect of increased heating rate.

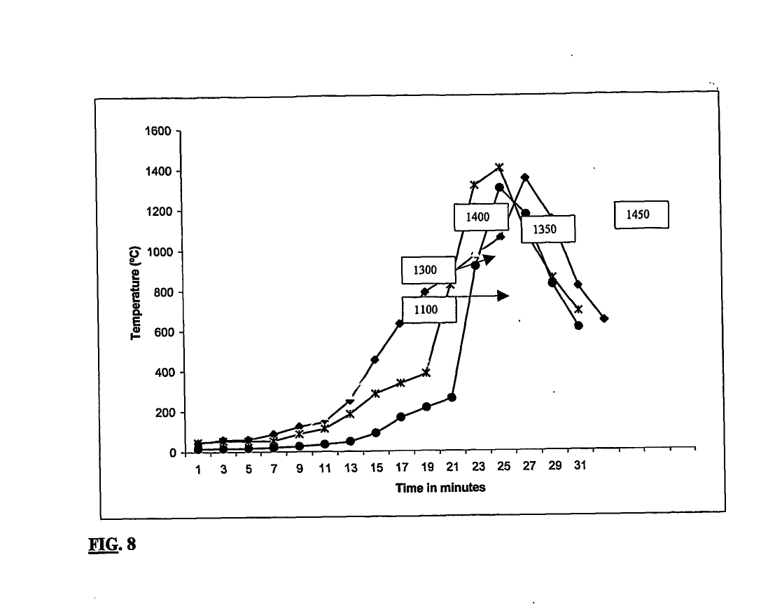

As shown in FIG. 6, a 10° C. per minute heating ramp rate resulted in a uniform temperature-time profile curve. The maximum sintering temperature of 1450° C. was reached in approximately two and half hours. The cooling ramp rate was also about 10° C. per minute to approximately 800° C. The cooling rate then slowed gradually over the next two hours to ensure that samples were not subjected to large thermal stresses. Conventional sintering of ceramic copings in dental labs takes approximately the same amount of time, depending on the actual heating and rates used. As shown in FIG. 6, it took approximately 1000 minutes, or roughly 16.6 hours, to complete the firing and cooling cycle from room temperature to room temperature.

The samples that were conventionally sintered at a heating rate of 10° C. per minute were densely sintered, however, and exhibited a translucent sheen that indicated that they were fully dense. The samples cooled to roughly around 250° C. after a period of about six hours.

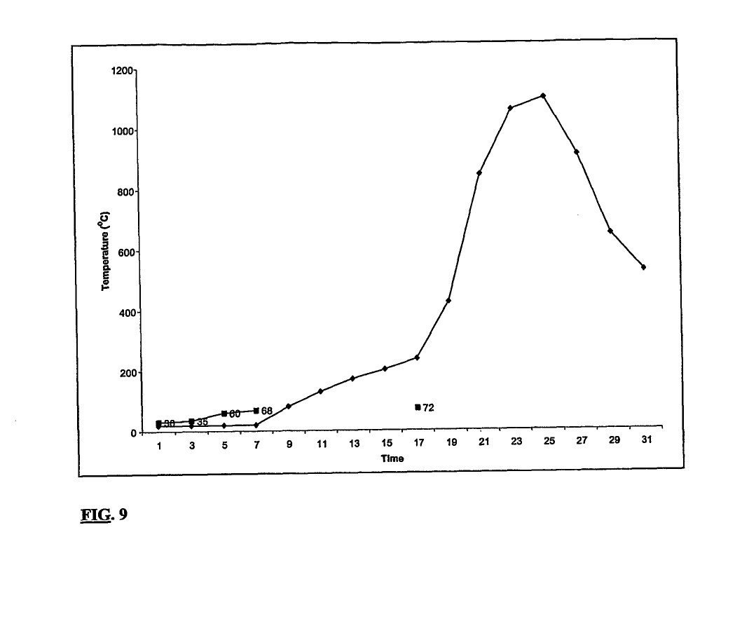

Conventional sintering using a faster ramp rate of about 35° C.-40° C. per minute was also evaluated to determine if the same or similar properties could be conventionally attained with faster ramp rates compared to the relatively slow ramp rate of about 10° C. per minute. The Lindberg furnace was programmed for a ramp rate of 40° C. per minute. FIG. 7 shows the time-temperature profile of this faster conventional firing. In view of the faster ramp rate of 40° C. per minute, the time to reach the sintering temperature of 1400° C. was approximately two hours, which is considerably less than the six hours associated with the 10° C. per minute ramp rate.

These samples, however, did not have the desired transparent sheen and the samples were warped compared to the samples that were heated at a 10° C. per minute ramp rate. These samples were not completely dense. This indicated that faster ramp rates resulted in insufficient sample sintering and thus, highly porous samples. Further mechanical tests were not implemented on these samples.

Sintering in the Microwave Furnace:

Microwave hybrid heating was employed to sinter samples. A multi-magnetron, 2 kW commercial microwave oven having a stainless steel cavity and equipped with dual mode stirrers was provided. The operating frequency was 2.45 GHz. A platinum sheathed S-type thermocouple and an Omega controller were procured from Microwave Research and Applications, INC (Model number BP 210/211).

A thermal fibrous alumina cylinder containment box was made from fibrous alumina boards one and a half inches thick, and 3 silicon carbide rings (25 mm in diameter) were used as primary susceptors. The containment box included a lid that could be opened and through which samples were introduced into the containment box. These SiC primary susceptors were sandwiched between reticulated zirconia plates. The reticulated zirconia plates were used a secondary susceptors and also as setters in that these plates were provided upon the floor of the thermal containment chamber to provide the floor upon which the samples rested in the microwave.

Two stainless steel pedestals with equally spaced 4 mm holes drilled in a direction perpendicular to the vertical axis were used to accommodate the S-type thermocouple. An 8 mm hole was drilled horizontally into the side of the cylindrical portion of the thermal containment cylinder. A fitted pyrolytic boron nitride sleeve was inserted to line the hole of the cylinder to ensure that no arcing would occur between the box and the thermocouple. The thermocouple probe was inserted to clear the aligned hole and allow temperature measurement within the cavity of the thermal containment box.

The placement of the thermocouple for accurate temperature measurements is also critical. That is, due to the high sintering temperatures, the possibility of arcing between the thermocouple and the sleeve exists, which would result in improper temperature measurements. The thermocouple tip (about 0.5 inches) was positioned right inside the thermal containment box to accurately measure the temperature. The actual sample temperature, however, might be 50-100° C. higher than the temperature displayed by the thermocouple read out for several reasons. That is, the thermocouple measured the heat contained within the thermal containment box and not the actual heat to which the samples are subjected. Since microwave heating is a volumetric heating phenomenon resulting in the interior of the samples being at a higher temperature then the surface, a temperature discrepancy of 50-100° C. from the display has to be taken into account considering the fast heating rates. Moreover, the thermocouple used was sheathed in platinum, which acts as a thermal barrier between the sample and the thermocouple and a thermal bridge between the sample and the exterior.

The experimental microwave sintering temperatures for microwave sintering Runs A-G are shown in Table I. Temperatures were manually recorded every two minutes. The microwave furnace was started at a minimal power level and the power level was gradually increased, as dictated by the desired ramp temperatures, until the maximum sintering temperature was achieved. The microwave furnace used did not have power feedback control. Therefore, whenever the temperature began to drop down, the power was increased to raise the temperature until the desired sintering temperature was attained. All sample-sintering cycles initiated at room temperature.

Since this microwave furnace was not water cooled, care was taken not to overheat it. Each set of subsequent samples was fired only after the oven had completely cooled from the previous run. The number of samples sintered in each run is also shown in Table I.

TABLE I
Experimental Microwave Sintering Temperatures for Each Run

| MW Sintering Run | Sintering Temperatures (° C.) | Number of Samples |
|---|---|---|
| A | 1100 | 4 |
| B | 1300 | 4 |
| C | 1350 | 4 |
| D | 1400 | 6 |
| E | 1450 | 10 |
| F | 1200-with dwell of 20 and | 4 |
| | 30 minutes | |
| G | 1700 | 2 |

This particular system lacked automatic power feedback controls. In order to achieve the desired temperature increase, the power of the microwave was adjusted accordingly. Faster heating and cooling rates (in excess of 150° C. per minute) that were used for the microwave sintering runs did not subject the samples to the types of thermal stresses which ordinarily may have cracked the samples. In contrast, however, when faster heating rates (40° C. per minute) were used in the conventional sintering runs, the samples warped or were distorted due to incomplete sintering.

The MHH system produced superior sintering in a shorter sintering period. As the microwaves were initially applied, they passed through and out of the thermal containment box, because the thermal containment box was made of fibrous alumina, which is a ceramic material that is transparent to the microwaves due a low thermal conductivity, but energy was retained within the box. The silicon carbide susceptors coupled well with the microwaves due to their high susceptibility to microwaves at room temperature and transformed this energy to infrared energy, which was emitted as heat.

As heat built up in the system, the temperature of the system increased. The heating rate was sufficiently high to realize high temperatures such that effective coupling of microwave energy with zirconia (both the reticulated zirconia plates and the sample) was achieved at the critical couple-triggering temperature. At this point, the zirconia became more susceptible to microwave energy, thereby absorbing the microwave energy at a greater rate than that of the silicon carbide susceptors. That is, once the temperature of the system was such that the SiC susceptors became reflective to the microwaves and discontinued radiant heat emission, the heat emitted from the secondary susceptors maintained the temperature of the thermal containment chamber and provided external radiant heat to the zirconia samples which, by that point, were also being internally and directly sintered by the microwave energy itself.

Thus, in this microwave hybrid heating system, the silicon carbide primary susceptors immediately coupled to the microwave energy and became infrared radiant heaters. The reticulated zirconia plates absorbed this thermal energy and increased the temperature of the system by radiating heat and acting as secondary susceptors to provide radiant heat after the microwave coupling-trigger temperature for the reticulated zirconia was met. The stabilized zirconia samples were heated by the radiant energy, initially emitted from the primary susceptors and then by secondary susceptors, until the couple-triggering temperature was met, whereby the stabilized zirconia sample material directly coupled to the microwave energy for sintering in cooperation with the radiant heat from the secondary reticulated zirconia susceptors.

When the temperature of the SiC primary susceptors reached about 695° C., the dielectric loss factor of the silicon carbide increased rapidly and the SiC susceptors became reflective to microwaves. The microwave couple-triggering of zirconia, however, is in a range of 300-600° C., depending upon the particular compositional ingredients present in the material, such as stabilizers or impurity elements. In that manner, before the silicon carbide susceptors became microwave reflective, the stabilized zirconia samples and reticulated zirconia plates were heated to their respective microwave coupling-trigger temperatures by the infrared radiation emitted from the silicon carbide primary susceptors, after which point the zirconia plates merely provided additional radiant heat for the system and the zirconia samples were heated by the thermal energy radiated from the secondary susceptors as well as direct microwave radiation until they were sintered.

It should be noted that the use of the steel pedestals to support the thermocouple within the microwave chambers in the experimental MHH set-up did not affect the sintering temperatures. Metals, unlike ceramics, are reflective to microwaves, and thus do not interfere with the microwaves unless they are overheated by pre-heaters to their melting temperature. Moreover, the measured temperatures would have fluctuated drastically if the metals had interfered with the microwave field.

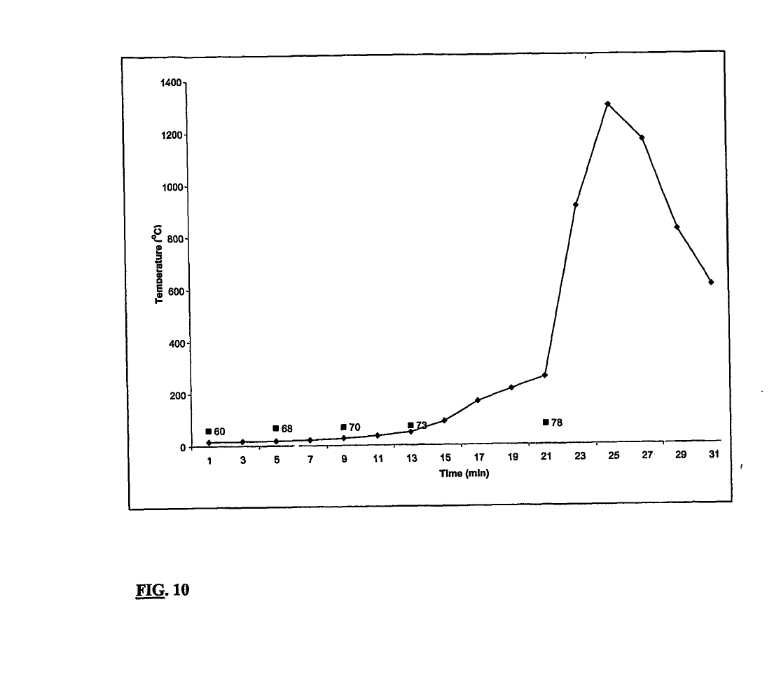

The sintering profile for each of the stabilized zirconia samples sintered in the experimental MHH system is shown in FIG. 8.

Run A (Microwave Sintering at 1100° C.):

Four samples were sintered at 1100° C. FIG. 9 shows the time-temperature-power profile for Run A, and shows that the ramp rate was in excess of 100° C. per minute. A maximum power of was 72% the maximum potential output was required to achieve the maximum sintering temperature of 1100° C. in a time of twenty-six minutes. The cooling rates were also constant and in excess of 100° C. per minute. The entire sintering cycle was completed in less than 35 minutes. However, upon removal of the samples after cooling, they were not completely sintered, and had warped to a certain extent.

Run B (Microwave Sintering at 1300° C.):

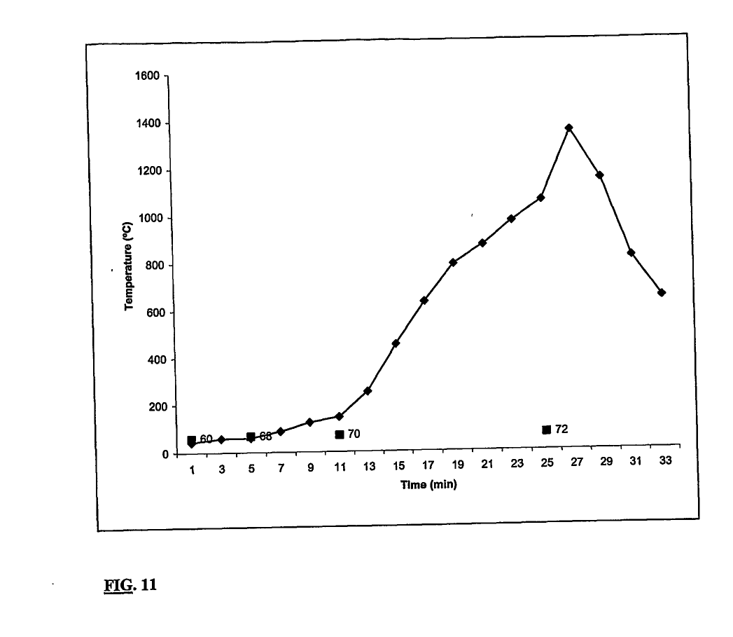

FIG. 10 shows the sintering profile used to sinter the Run B samples to a maximum temperature of 1300° C. The maximum power required was 78%. During this cycle, however, the temperature rose very slowly from room temperature to about 150° C. at a heating rate of 10° C. per minute. Increasing the power to 73% raised the ramp rate significantly until a temperature of about 300° C. was reached, and then the delivery of 78% power further increased the ramp rate to more than 150° C. per minute.

The Run B samples were dense and did not show any warping. The normally expected cracks, i.e., those which ordinarily occur when samples are subjected to thermal shock, did not occur here. These samples were small, however, and as such, they were not subjected to larger thermal stresses that would ordinarily be associated with larger samples. Since actual dental ceramic restoration pieces are also small, however, faster heating rates such as those in Run B would not adversely affect the samples and could be practically implemented by dentists or dental lab technicians.

Run C (Microwave Sintering at 1350° C.):

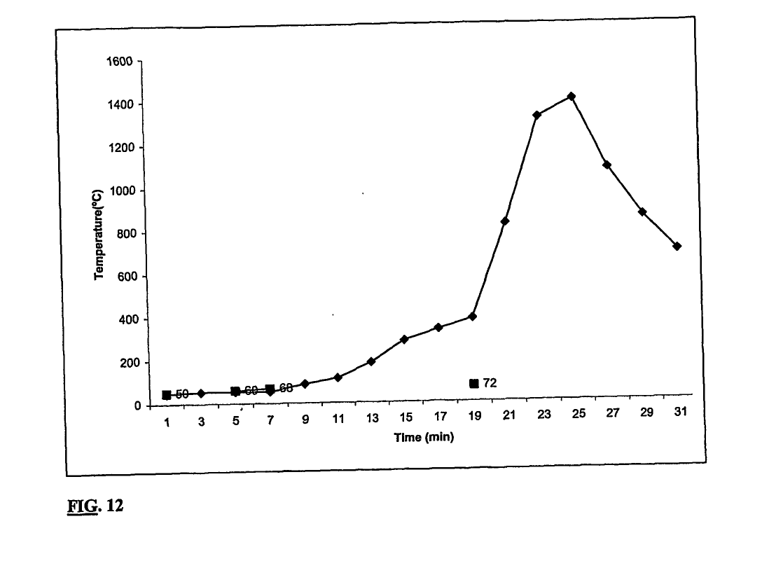

As shown in FIG. 11, when the temperature started to waiver around 200° C., the power was increased to 70%. The temperature then increased from 150° C. to 1000° C. at a rate of 71° C. per minute. This increased ramp rate is lower than the ramp rates of Runs A and B, which exceeded 100° C. per minute. Upon examination, the cooled samples appeared to be completely sintered.

Run D (Microwave Sintering at 1400° C.):

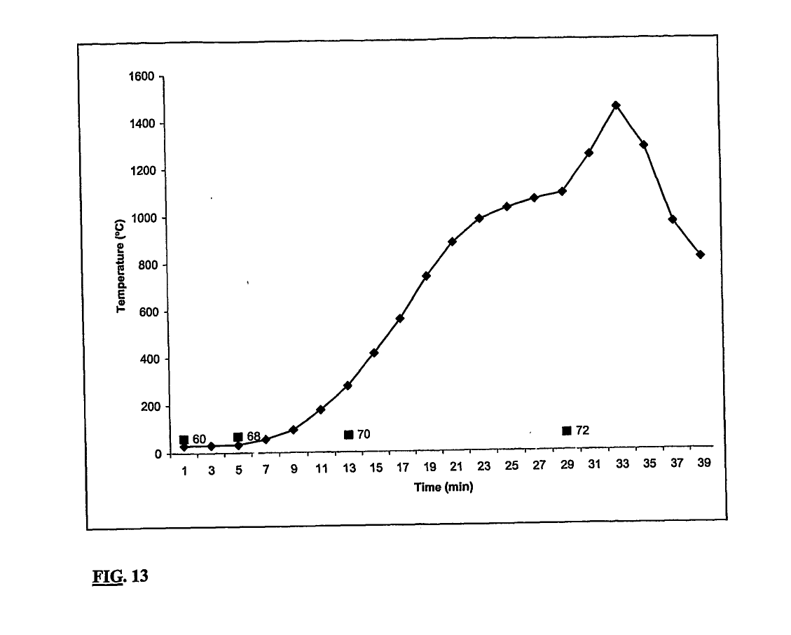

The power was manipulated until the temperature reached about 380° C. As shown in FIG. 12, the final power level of 72% increased the microwave heating such that a heating rate of approximately 150° C. per minute was employed until the maximum sintering temperature of 1400° C. was reached. Upon examination, the cooled Run D samples were intact, did not show any signs of cracking and had a desirable translucent sheen, which was not observed in the samples from the sintering profiles followed in Runs A-C.

While the possibility of thermal stress generation is always a reality with such rapid heating rates, the heating and the cooling rates were almost equal. Moreover, for the first nineteen minutes of the sintering run, the heat of the thermal containment box provided the initial sintering mechanisms for the samples, such that when the high heating rate was applied, the samples readily absorbed the microwave radiation and sintered rapidly.

Run E (Microwave Sintering at 1450° C.):

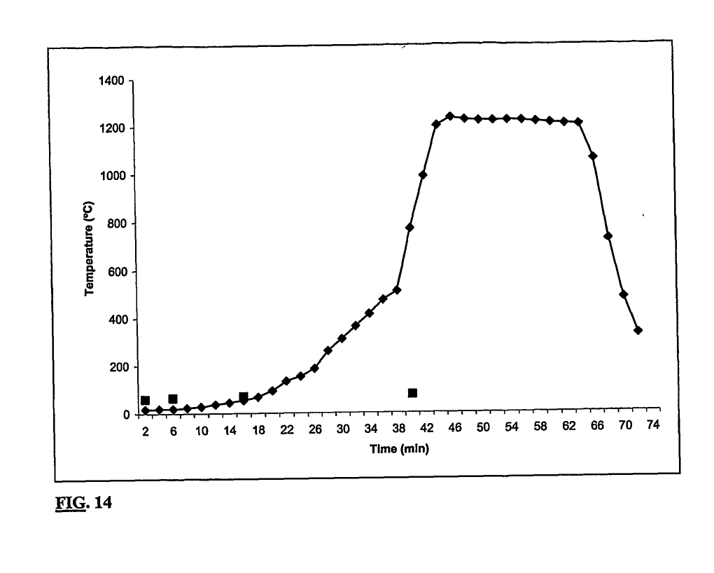

FIG. 13 shows that the Run E time-temperature profile represented a more uniform heating curve with a ramp rate of approximately 60° C. per minute compared to the microwave sintering profiles of Runs A-D. A maximum power of 72% was adequate to reach the sintering temperature of 1450° C. The cooling rate followed the same schedule as the previous cycles. The overall time required to complete the cycle was extended, however, due to the slower ramp rate. The ten samples sintered according to this cycle displayed a desirable translucent sheen and were completely sintered.

Run F (Microwave Sintering at 1200° C. with Dwell Times of 20 and 30 Minutes):

One potential benefit of using microwave sintering systems is that such a system may enable lower temperature sintering. As shown in Run A, however, a low temperature of 1100° C., with no dwell time was insufficient to sinter the samples. Thus, Run F examined the results of microwave sintering at a relatively low sintering temperature of 1200° C. with a dwell time. FIG. 14 shows the Run F sintering profile including a dwell time of 20 minutes. The power was increased as necessary to cause a corresponding temperature increase.

Since the microwave furnace that was used lacked water-cooling mechanisms, it was difficult to hold the temperature at 1200° C. for a prolonged period. Moreover, for each of the runs with dwell times of 20 and 30 minutes, the Teflon floor of the microwave oven expanded, forming a bubble below the thermal containment box. This phenomenon was attributed to the fact that when microwaves pass through and out of the thermal containment box, heat is contained within the box because of low thermal conductivity of the fibrous alumina. Additionally, the outside of the containment box was cooler than the inside. For example, the temperature at the outside region may be around 200° C., compared to the inside of the box (1350° C.). Further, there was not complete air circulation at the bottom of the box to compensate for the heat that dissipated below the box. Also, the coefficient of thermal expansion for Teflon (i.e., the floor of the microwave) is very high (12-13 inch/inch/° C.). Because of the high coefficient of thermal expansion of Teflon, for every degree of temperature increase there is corresponding increasing in length until it expands and buckles. Thus, when heat flows from the box, the Teflon expands either above or below the box; in this case it did so by forming a bubble.

For the run including a dwell time of 30 minutes, the containment box was repositioned away from the buckled areas of the microwave floor, but the results were similar. Further runs with dwell times were not performed.

Run G (Microwave Sintering at 1700° C.):

The initial power was set at 75%. After two minutes, the power was increased to its maximum of 100%. The heating ramp rate exceeded 150° C. per minute, and the sintering temperature of 1700° C. was reached in about ten minutes. Although these microwave-sintered samples were completely dense, this high sintering temperature damaged the microwave furnace such that the floor was completely burned.

Post-Sintering Measurments for Conventionally Sintered and Microwave Sintered Samples:

Dimensional Measurements:

The conventional and microwave sintered cylinders were measured using a micrometer with respect to their length, diameter, and the samples were also weighed. The differences between the pre-sintered and the post-sintered samples were recorded. There was not any significant, statistically measurable difference between the post-sintering dimensions (i.e., shrinkage characteristics) for conventionally sintered and microwave-sintered samples.

Bulk Density:

Bulk density measurements were performed for each sample according to ASTM standards. The post-sintered weight was measured as the dry weight (D). The samples were placed in deionized water and boiled for two hours. After the boiling period, the immersed samples remained undisturbed for twelve hours. Using Archimedes method, the saturated weight (S) of each sample was measured. Once the samples were removed, they were dried throughly, and the wet weight (W) was recorded. The Volume, Bulk Density and Percentage Density were recorded based on the following formulae:
Volume (V)=Wet weight (W)−Saturated weight (S) Bulk Density (B)=Dry weight (D)/Volume (V)
Percentage Density=(Bulk density/Theoretical density*)×100

*A Theoretical Density of 6.06 was utilized for our calculations of the percentage density.

Density Results:

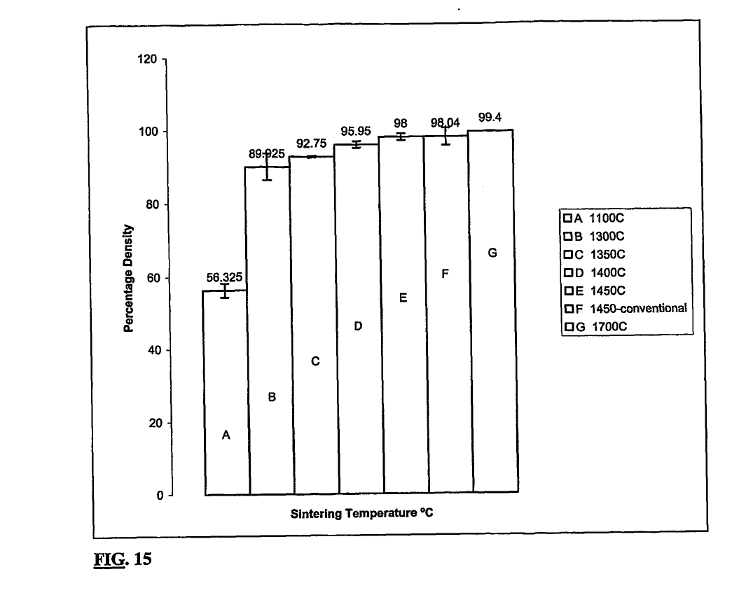

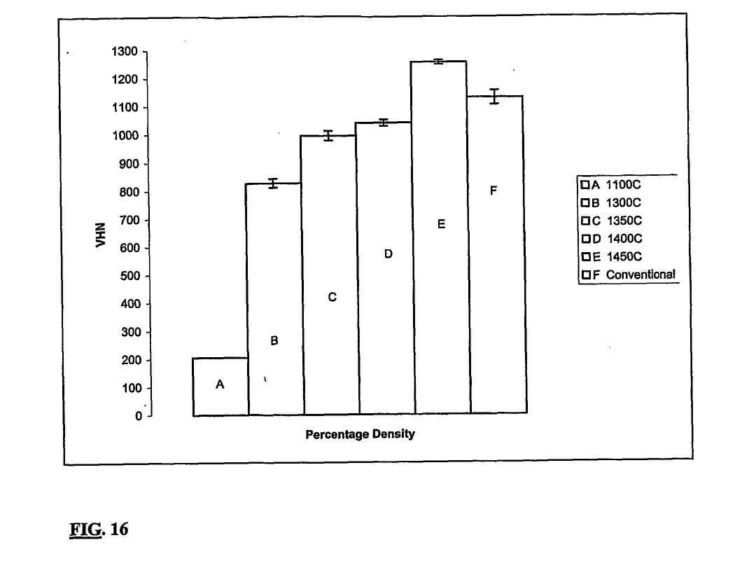

As expected, the most significant factor affecting the density of both the microwave-sintered samples and the conventionally sintered samples was the maximum sintering temperature. The density increased with the sintering temperature. For Runs A-C, the lower microwave sintering temperatures of 1100° C., 1300° C. and 1350° C. resulted in samples with a considerably lower density than the conventionally sintered samples. The densities of the microwave-sintered samples from Run D, however, which were sintered at 1400° C., were comparable with that of the conventionally sintered samples heated to 1450° C. at a rate of 10° C. per minute. Further, there was not a significant difference between the density of the Run E samples (microwave-sintered at 1450° C.) and the conventionally sintered samples, as shown in FIG. 15.

Overall, the density-temperature relationships for microwave sintering Runs A-F and the conventional sintering run at 1450° C. with a 10° C. per minute ramp rate are shown in Table II. As mentioned above, noticeable differences in density as a function of temperature were found at the low sintering temperature samples (Runs A-C). The lower densities of the samples that were microwave-sintered at lower temperatures were attributed to the reduced amount of time available for densification (insufficient time for mass transport). Increasing the ramp rate, however, did not significantly impact the density-temperature relationship between the conventionally sintered and the microwave-sintered samples.

Summarily, the conventionally sintered samples heated to 1450° C. at heating rates of 10° C. per minute compared well with the faster heating rates of microwave-sintered samples from Runs D and E. The Run G sample, which was microwave-sintered at 1700° C., had the maximum density compared to the other sintering temperatures. This corresponded to the fact that the Run G sample had a higher sintering temperature compared to Runs A-E and the conventional run.

TABLE II
Percentage Density for Each Microwave Sintering Run vs.
Conventional Sintering

| | Sintering Temperatures | |
|---|---|---|
| MW Run | (° C.) | Percentage Density ± S.D. |
| A | 1100 | 56.3 ± 3.7 |
| B | 1300 | 90 ± 2 |
| C | 1350 | 93 ± 0.2 |
| D | 1400 | 96 ± 0.9 |
| E | 1450 | 98 ± 0.9 |
| Conventional | 1450 | 98.04 ± 2.37 |
| G | 1700 | 99.4 ± 0.1 |

Hardness and Toughness Measurements:

Indentation hardness numbers and fracture toughness are extensively used in evaluating the potential performance of dental materials. A Vickers Indentation hardness tester was used for this study. The Indentation fracture technique has been established as an accurate procedure for determining the approximate fracture toughness for brittle materials. Three samples from each lot for each of the microwave sintering Runs A-E shown in Table I were measured, and six of the conventionally fired samples that had the highest percentage density were measured.

Sample Preparation for Hardness and Toughness Measurements:

The samples were each sectioned by a diamond blade, and mounted on a thermosetting epoxy mount. The samples were then polished with grit progressing from 120, 240, 340 and 600. The final polishing was performed with a series of decreasing diamond pastes from 30, 15, 6 and 1 μm. Times were varied from one to five minutes at each stage. The samples were observed under the optical microscope to check for any polishing scratches and, if present, the samples were re-polished to ensure accurate measurements.

Static Hardness and Indentation Toughness Measurements:

Static hardness testing was done using a Vickers Hardness Tester. Indentation loads of 20 Kg and 30 Kg were employed with a hold time of 5 seconds for each sample during indentation. Five indentations were made on each sample. The mean diagonal length and the corresponding crack length were measured using the guage meter attached to the equipment.

The Vickers Hardness number and the indentation fracture toughness were calculated as follows:
Vickers Hardness (Hᵥ)=1.854 P/d²;

Where 1.854 is the geometric factor for Vickers indenter (from sin 68°),

P is the test load (in kg) and d is the mean of both diagonals (in mm).

Fracture Toughness (K_{IC})=0.016 P/c ^{1.5}(E/H)^{0.5}

Where c=crack length from center of indent (in meters)
P=Load (in Newtons),
E=Youngs modulus (in GPa), and
H=Vickers Hardness (in GPa).

Indentation Hardness Results:

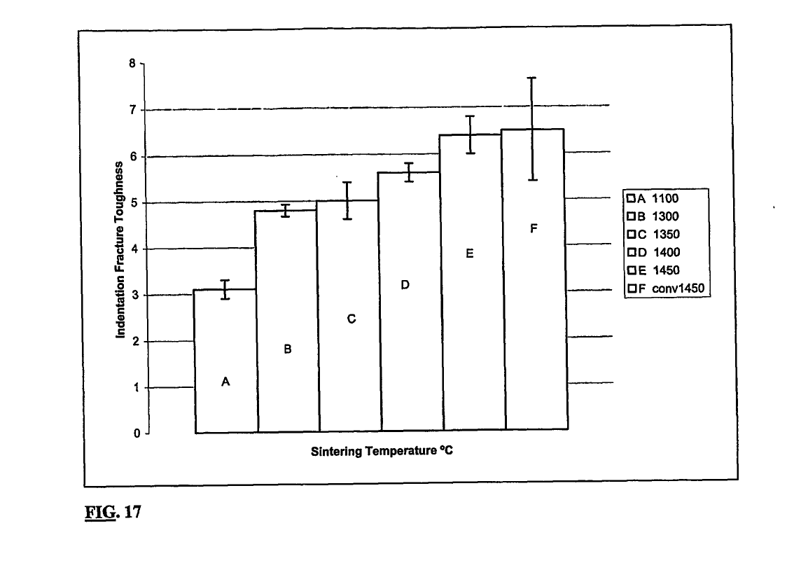

The sintering temperature influenced the indentation hardness and the fracture toughness values for the various microwave-sintered samples under both 20 Kg and 30 Kg loads. As shown in FIG. 16, a linear relationship exists between the Vickers hardness number and the percentage density of the sintered samples tested under 20 Kg loads. Table III shows the relationship between the Vickers hardness values for both 20 Kg and 30 Kg loads and the corresponding sintering temperatures for the microwave sintering runs.

The hardness numbers were significantly lower for samples that were exposed to microwaves for short periods of time. The hardness values for samples microwave-sintered at 1450° C. (Run E) are significantly higher than that of conventionally sintered samples at 1450° C. Moreover, the hardness values for microwave-sintered samples of Run D (1400° C.) were also comparable with that of the conventionally sintered samples at 1450° C.

The hardness values of the microwave samples sintered at 1450° C. are comparable with that of the published values for conventionally sintered zirconia when used as a dental biomaterial. The volumetric heating by the microwaves resulted in better mechanical properties when compared to the conventionally sintered samples. Thus increasing the ramp rate, as in case of the microwave-sintered samples, did not have any deleterious effect when compared to the slow ramp rate of conventional sintering.

Since natural teeth are frequently subjected to stresses from 50 N to 500 N, any dental material that replaces natural dentition should also be able to withstand such forces. A comparison between conventionally sintered samples and microwave-sintered samples tested under 30 Kg loads yielded similar results. That is, the microwave-sintered samples sintered of Run E (1450° C.) displayed higher hardness values than the conventionally sintered samples at 1450° C., as shown in FIG. 12. This could be attributed to volumetric heating, which resulted in both uniform and improved microstructure.

TABLE III
Vickers Hardness Numbers for Microwave-Sintered Samples and
Conventionally Sintered Samples at 20 Kg and 30 Kg Loads

| MW Run | Sintering Temp. | VHN ± S.D. (20 | VHN ± S.D.(30 |
|---|---|---|---|
| A | 1100 | 206 ± 0.7 | 275 ± 7.8 |
| B | 1300 | 827 ± 16 | 863 ± 45 |
| C | 1350 | 994 ± 17 | 895 ± 7 |
| D | 1400 | 1039 ± 11 | 1035 ± 10 |
| E | 1450 | 1256 ± 7 | 1267 ± 18 |
| Conventional | 1450 | 1130 ± 25 | 1237 ± 29 |

Fracture Toughness Results:

The fracture toughness was calculated from the measured radial cracks around each indent made under HV₂₀ and HV₃₀ loads. The fracture toughness increased with sintering temperature as shown in FIG. 17.

The HV₂₀ indentations of microwave-sintered samples from Run E were comparable with those of the samples that were conventionally sintered at 145020 C. The increase in the standard deviation for conventionally sintered samples is attributed to non-uniform grain size in these samples. Cracks that were measured at the center of the samples propagated more than those measured at the edges of the samples. Because the surface energy for diffusion mechanisms is different from the exterior to the interior, the grains at the edges were considerably smaller than those at the centers, which had more energy absorption when indented and prevented further propagation of the crack.

Volumetric heating by microwaves resulted in more uniform grain size distribution and the values obtained were substantially similar throughout different areas of the samples that were measured. The low indentation fracture toughness values for the microwave-sintered samples of Run A (1100° C.) may be due to the presence of cracks which acted as local stresses and lowered the fracture toughness values. Also, the low percentage density of 56.325±3.7 was not sufficient enough to increase the fracture toughness.

As shown in Table IV, the fracture toughness values for HV₃₀ were higher. The transformation toughening mechanisms imparted to zirconia that is stabilized with 3 mol % yttria increases the resistance to crack propagation and results in higher fracture toughness. Moreover, the amount of transformed grains, or the size of transformation zone, depends upon the transformability of the tetragonal phase, which is controlled mainly by the grain size. While microwave sintering resulted in uniform and smaller grains, more grains transformed and absorbed the energy of the crack, which resulted in slightly higher fracture toughness values.

Also, the fracture toughness values are influenced by the mode of crack propagation. If cracks pass trans-granularly, more energy is required to propagate, and the transformability of the tetragonal phase will absorb some of the energy and clamp the crack shut, thus removing the energy for the crack to proceed. The cracks may also pass through inter-granularly, however, and by the time the transformation toughening mechanisms is complete, these cracks would have sufficient energy to proceed before being completely clamped.

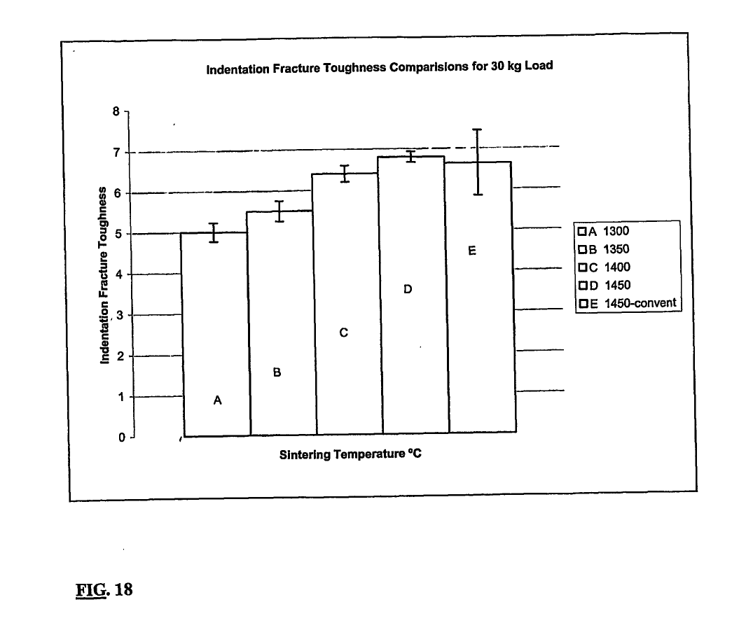

Sample preparation also influences the cracks measurements to a certain extent. It was difficult to observe the complete length of the cracks at HV₃₀ for the Run A samples, and these were not included in the comparison. The indentation fracture toughness values and the values of microwave-sintered samples from Run D (1400° C.) are comparable with the conventionally sintered samples. The microwave-sintered samples of Run E (1450° C.), however, had a slightly higher value. FIG. 18 shows a comparison between the fracture toughness values under 30 Kg loads for the samples of Runs B-E and the conventionally sintered sample.

TABLE IV
Fracture Toughness Values for Microwave-Sintered Samples
and Conventionally Sintered Samples at 20 Kg and 30 Kg

| | Sintering | | |
|---|---|---|---|
| | Temperatures | Kic (20 Kg) ± S.D | Kic (30 Kg) ± S.D |
| MW Run | (° C.) | (Mpa · m^{0.5}) | (Mpa · m^{0.5}) |
| A | 1100 | 3.1 ± 0.2 | Inaccurate |
| B | 1300 | 4.8 ± 0.13 | 5 ± 0.23 |
| C | 1350 | 5 ± 0.4 | 5.5 ± 0.3 |
| D | 1400 | 5.6 ± 0.2 | 6.4 ± 0.2 |
| E | 1450 | 6.4 ± 0.4 | 6.8 ± 0.13 |
| Conventional | 1450 | 6.5 ± 1.1 | 6.6 ± 0.8 |

Microscopic Examination:

The mechanical properties of the samples are influenced by the microstructure, but are also influenced by defects, as well. Both the details of the microstructure and the presence of defects were microscopically examined.

The samples were removed from the epoxy mounts and cleaned in an ultrasonic bath of deionized water for 30 minutes to remove residual epoxy material. The samples were either thermally or chemically etched for examination under the microscope. Microwave Sintered samples from Runs A (1100° C.), B (1300° C.) and C (1400° C.) were etched with 49% Hydrofluoric acid for 3 minutes. The conventionally sintered and the other microwave-sintered samples were thermally etched to a temperature of 100° C. less than the sintering temperature and held for one to one and half hours (more for the microwave-sintered samples).

The samples were sputter coated for 3 minutes to provide a 300 Å thick coating of gold palladium and then examined under a Scanning Electron Microscope. The conventionally sintered samples were examined with an ETEC while the microwave-sintered samples were examined using a PHILIPS electron microscope.

Microstructure Results:

The microstructure of the dental ceramic samples consisted of granular aggregates that are typically seen for these types of ceramics. In general, the average microstructure of the microwave-sintered samples had less voids than the conventionally sintered samples at the same magnification of 10000×. No significant difference in grain shape was observed between the two sintering methods.

The samples that were conventionally sintered samples at a ramp rate of 10° C. per minute had slightly larger grains (approximately 0.7 μm) in the interior than the exterior, approximately 0.3 μm. This indicated that the temperature of the external surface might have been higher than the interior. Few voids were also seen in these samples.

The microwave-sintered samples had uniform grain size distribution, which was closely packed, but had less porosity than the conventionally sintered samples. The microstructure was more uniform throughout the sample and confirms the volumetric heating phenomenon. The average grain size was approximately 0.3 μm. Thus, the faster ramp rates used in the microwave sintering Runs did not alter the overall microstructure.

Thermal etching brought out excellent microstructural features. Chemically etching the microwave-sintered samples, however, did not enhance the reproducibility of the granular microstructure. Most of the grains appear to be chewed up. The microwave-sintered sample from Run A (1100° C.) revealed the presence of fine cracks, which decreased the fracture toughness values. This was mainly due to improper sample preparation rather than thermal stresses. The microstructure of the microwave-sintered samples from Run D (1400° C.) included a few slightly larger grains (0.5 μm) interspersed among the densely packed smaller grains (0.3 μm).

### Experiment 2

### Microwave Sintered Ceramic Coated Copings vs. Conventionally Sintered Ceramic Coated Copings

Zirconia dental copings, stabilized with 3-mol % yttria, were layered with dental glass ceramic shades and sintered in a conventional dental lab furnace and in the microwave hybrid heating system furnace. Excellent aesthetic results were obtained by microwave sintering in shorter periods of time with rapid ramp rates compared to the relatively slow conventional heating rates.

The microstructure included uniform crystal distribution in the glassy matrix for the teeth sintered gradually as compared to the rapid sintering by microwave. However, the degree of crystallinity of the gradually fired microwave sample is higher than those of rapidly fired samples. Thus, by varying the dwell time, the size and amount of crystalline phase can easily be controlled during the sintering process.

Indentation hardness and fracture toughness measurements were conducted under HV_{0.5} and HV_{0.2} loads. The indentation hardness and fracture toughness values of the microwave-sintered samples compared well with the published values for conventionally sintered dental ceramic materials reported in the literature. The presence of internal stresses may have contributed to the significant difference in the fracture toughness values observed between the rapidly fired and gradually fired samples.

The strength of dental ceramic materials that were microwave-sintered onto zirconia bars samples were tested in a four-point bend test. The results of the modulus of rupture data showed that the microwave-sintered samples were comparable with the MOR values for conventionally sintered samples reported by other researchers. However, the MOR values were lower compared to the MOR values for the uncoated bars.

Sample Materials:

Six anterior (front teeth) copings and ten posterior (molars or chewing teeth) copings, made from sintered zirconia stabilized with 3 mol % yttria, were provided by Town and Country Dental Laboratory (Freeport, NY) and Nobel Biocare (Yorba Linda, CA). Town and Country Dental laboratory also provided the dental glass-ceramic (NORITAKE, Japan) coating materials that were compatible with the zirconia copings.

The dental glass-ceramic materials for enameling the copings were supplied in the form of fine powders, which were mixed with modeling liquid and condensed into the desired form. The particle size distribution of the powders play a key role in producing the most dense packing when the powders are properly condensed. The powder particles of shade base, dentine shade, enamel shade and the luster shades provided each had a different particle size distribution to ensure optimum packing density. Lower firing shrinkage and less porosity can be obtained by dense particle packing behavior of the powder particles.

The zirconia copings were cleaned with de-ionized water in an ultrasonic bath. Four basic shades of dental glass-ceramics were used in this experiment: the shade base; a dentine shade; an enamel shade; and a luster shade. The different colors of the layers are provided by pigmented oxide additives, i.e., the blue appearance of the enamel shade was due to the addition of cobalt oxide and the opacity of the opaque base was due to the presence of zirconium, titanium, or tin oxides.

The forming liquid, or modelling liquid (starch and sugar along with distilled water), was mixed with each shade as described below. Excess water was blotted away from the layers to ensure optimum powder packing on the zirconia copings. A soft grip (SG-250) was used to mix the cement and the forming liquid on a dental cement mixing pad.

Enameling the Copings:

The shade base, that is, the opaque layer, was dispensed on the mixing pad and mixed with the forming liquid. The consistency of the mix was important and care was taken to obtain the optimal consistency and texture of the mix. A mixing ratio of one part powder to one part forming liquid was used. Application of the layers of the dental glass-ceramic in their right consistency was also crucial to obtaining dense particle packing of the powder. The thick creamy pasty mix was not allowed to drop off of the applying medium. The copings were held with tweezers, and the opaque shade was applied to the copings by the mixing brush. The tweezer was lightly tapped during the application of the opaque shade. The soft grip brush coated the layers very evenly, however, a spatula can be used to smooth the wet dental glass-ceramic.

Once the opaque layer was applied, the dentine shade was mixed and applied in the same manner as described and applied over the first layer. Similarily, the other two layers were mixed and applied accordingly to the manufacturer's instructions and the final carving of the occlusal anatomy (tooth countour) was made by a sharp probe. Overcoating was avoided in order to reduce the occurrences of uneven surfaces.

Conventional Sintering of Enameled Copings:

One at a time, two posterior samples layered with the dental glass-ceramic were sintered in the conventional furnace. For conventional sintering, two fabrication processes were employed. One coping was layered with the first shade of glass-ceramic (opaque or shade base) and fired in the furnace, and then the other layers were applied and likewise fired. Additionally, the technique of sintering one layer at a time was also used. The experimental thermal schedule followed is shown in Table V.

A conventional furnace typically used by dental laboratories was employed. The firing schedule was followed as per the instructions. The furnace was pre-heated to 500° C., and the condensed porcelain was placed in front of the muffle of the pre-heated furnace. After preheating for five minutes, the coping layered with the dental glass-ceramic was placed into the furnace (automatically, given furnace automation) and was heated to 900° C. at rate of 90° C. per minute. After the firing cycle was completed, the restorations were removed and examined. The second layer of dentine and enamel shades was applied and the same firing cycle was repeated. Upon cooling, the restoration was examined and, again, due to lack of consistency, individual shades were reapplied and a slower heating rate of 70° C. per minute was employed. Only the enamel and the luster shades were applied and re-fired with a rate of 50° C. per minute until the optimum smooth finish was obtained.

The other coping layered with the dental glass-ceramic, however, was subjected to a single firing with faster heating rates in the same manner as the microwave sintering. The heating rate was 100° C. per minute. The conventional firing cycle mentioned above was initiated and the sample was sintered to 925° C. and allowed to complete its cycle. The shades of enamel and luster had to be reapplied two additional times and firing was conducted at a much slower heating rate of 50° C. per minute.

Conventional Fast Firing:

There was no change in the technique of forming the layers of dental glass-ceramic on the zirconia copings. The sintering schedule was not followed according to the manufacturer's conventionally recommended instructions of 40-50° C. per minute, but instead, a ramp rate of 90° C. per minute was used for one sample to provide a comparison between faster heating rates for both conventional and microwave sintering processes.

The furnace was pre-heated to about 500° C. The tooth was placed on a fire-clay tray and inserted into the muffle of the furnace to preheat the sample and allow any remaining water to vaporize. The furnace preheating temperature varies from one laboratory to another. Pre-heating is required because placement of the condensed coating materials directly into a warm furnace would result in rapid production of steam, thereby introducing many voids that would ultimately fracture the sections of the tooth. After preheating for about five minutes, the firing cycle was initiated.

The faster ramp rate of 90° C. per minute enabled a temperature increase from 500° C. to 925° C. within a period of five minutes. The cooling rates were also about 90° C. per minute. Once the temperature fell below 150° C., the restoration was removed. Upon examination, the restoration appeared cracked and was highly porous. The major content of the glass-ceramic powder was leucite, and changes in the leucite content caused the generation of sufficient stresses that led to cracking in the porcelain. Also, the bond strength between the layers appeared to be very weak and they chipped easily. Since the layers could easily be removed, the enamel and the dentine shades were recoated on the coping. The sample with the reapplied layers was sintered along with the other sample using the standard procedure for firing dental crowns.

Conventional Incremental Firing:

Incremental firing pertains to the individual application and sintering of each layer of the dental glass-ceramic. For one sample, the opaque base was applied, and the sample was dried in front of the open door of a pre-heated furnace. When completely dry, the sample was automatically inserted into the furnace and then fired with a ramp rate of 50° C. per minute to 925° C. The sample was automatically cooled by the furnace operational system and the tray was removed with a long pair of tongs. This process took around twenty-five minutes.

During cooling, a few bare spots were noticed, which had to be re-covered with sufficient opaque shade, since smooth surfaces are required to produce strong bonds with the other layers. The sample was placed into the furnace following the same procedure. After complete cooling, the dentine shades and enamel shades were applied following the same procedure. Additional porcelains were added on the occlusal surfaces until optimum restoration was attained. The final layer, luster, was applied and sintered with the same firing schedule until a restoration offering a good finish was obtained.

The entire process was completed within three and a half hours using just the basic shades of the dental glass-ceramic. An average dental laboratory, however, uses upwards of 20 to 40 different shades of glass-ceramic in order to obtain the ideal shade. In that manner, conventional incremental firings normally require four to five hours to obtain completed restorations.

Microwave Sintering of the Enameled Copings:

Each sample was placed upon the reticulated zirconia in the thermal containment box and the same Microwave Hybrid Heating (MHH) technique described above was used to microwave sinter the coated samples. Temperature measurements were taken every two minutes. The power was increased gradually for few samples and for few other samples the power was increased rapidly (rapid bursts) as shown in Table V. The sintering temperature was about 800° C. with a hold time of one minute. One sample, however, was fired to approximately 700° C. with a hold time of one minute.

TABLE V
Experimental Thermal Schedules for the Coated Copings

| | | Start | | Final | |
|---|---|---|---|---|---|
| | | Temp. | Heat Rate | Temp. | Hold time |
| Furnace | Process | (° C.) | (° C./min) | (° C.) | (minutes) |
| M/W | Single firing | Room | Gradual | 800 | 1 |
| | Single firing | Room | Rapid | 800 | 1 |
| | Single firing | Room | Gradual | 700 | 1 |
| | Single firing | Room | Gradual | 800 | No Dwell |
| Conventional | Single firing | 500 | 90 | 925 | 2-3 |
| | First bake | 500 | 50 | 925 | 3 |
| | Second bake | 500 | 50 | 925 | 3 |
| | Third bake | 500 | 50 | 925 | 3 |

One at a time, four anterior samples were microwave-sintered. Two anterior samples were sintered with rapid bursts of power. The resultant aesthetic properties were noted. Each sintered tooth sample was examined for uniformity. Three samples, (two which were sintered under rapid bursts of power and the sample that was fired at 700° C.) were found to be very rough, and there was a lack of good translucency (i.e., the samples were not aesthetically pleasing). These samples were re-coated with the layers of enamel and luster, re-fired with a gradual increase of power and sintered to 800° C. with a hold of one minute. The microwave power was terminated at the desired temperature of 800° C. after the one-minute hold time. The cooling temperature profile was also recorded every two minutes.

Subsequently, the posterior coping samples were enameled with the layers of the dental glass-ceramic. These samples were fired with the power-temperature profile that worked well with the anterior tooth copings. One at a time, four teeth were sintered with the preferred power-profile shown in Table VI. The remaining six coping samples were placed on the reticulated zirconia floor in the thermal containment box and gradually fired to approximately 800° C. according to the thermal schedule shown in Table VIII.

Microwave Sintering Profile for the Enameled Copings:

As described above, the conventional method of firing the layered (enameled) dental copings involves multiple sintering runs with sintering temperatures on the order of 900-960° C. and dwell times of about three minutes for each of the incremental runs. The present invention processing technology, however, facilitates the use of lower temperatures and a reduced sintering period, and allows many crowns or restorations to be fired at once.

For these experiments, the microwave sintering temperatures ranged from 700-800° C., with a dwell time of one minute. The overall experimental sample profile is shown in Table V. For the samples that were fired according to the schedule shown in Table VI, an initial soak period at a low temperature was provided to ensure that the water in the layered dental ceramic materials was removed. This procedure is comparable to conventional methods, where the copings layered with dental ceramics are placed in the muffle of a pre-heated furnace for few minutes to remove water prior to sintering.

TABLE VI
Microwave Sintering Schedule for Enameled Copings Fired
One at a Time

| Time (minutes) | Temperature (° C.) | Power (percentage) |
|---|---|---|
| 1 | 29.8 | 30 |
| 3 | 32.2 | |
| 5 | 32.6 | 60 |
| 7 | 33.8 | 70 |
| 9 | 84.1 | |
| 11 | 144.6 | |
| 13 | 203.6 | 74 |
| 15 | 812 | |
| 16 | 804 | |
| 18 | 670.1 | |
| 20 | 468 | |
| 22 | 347.2 | |

Microwave Sintering at 800° C.:

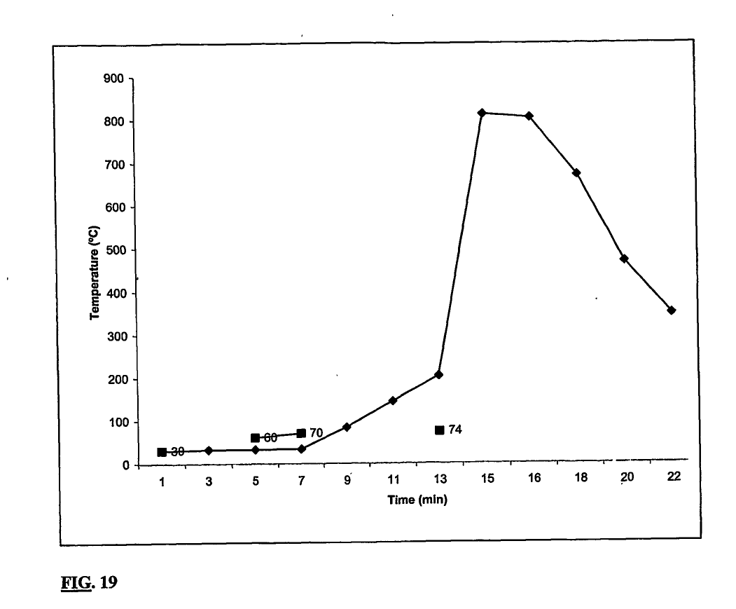

The temperature-power-time profile of FIG. 19 shows that the initial ramp rate was around 40° C. per minute. The microwave-sintered samples were exposed to a pre-heat period, during which the temperature varied for ten minutes. At 200° C., the power was increased and a ramp rate in excess of 270° C. per minute brought the sample to the sintering temperature. The temperature was maintained at about 800° C. for a one-minute dwell period, and then the microwave power was terminated.

The cooling rates were not controlled, but were approximately 110° C. per minute. After the furnace cooled to a temperature below 150° C., the furnace was opened for further cooling. The entire sintering process was completed less than 25 minutes. Cooling rates in excess of 100° C. per minute had no deleterious effect (e.g., cracking) on the sintered restorations. This is a major advantage of using microwave sintering in making dental restorations.

It should be noted that the thermochemical reactions between the ingredients occurred during the original manufacturing process for each of the powdered ingredients, and that the purpose of the firing was merely to ensure the proper fusion of the powders to completely form the restoration. The restorations exhibited an excellent finish with natural translucent surface.

Microwave Sintering at 700° C.:

The primary objective of sintering samples at a temperature of 700° C. was to determine if microwave process would enable restorations to be sintered at temperatures that are about 250° C. less than the final sintering temperatures for conventional firings (920-950° C.).

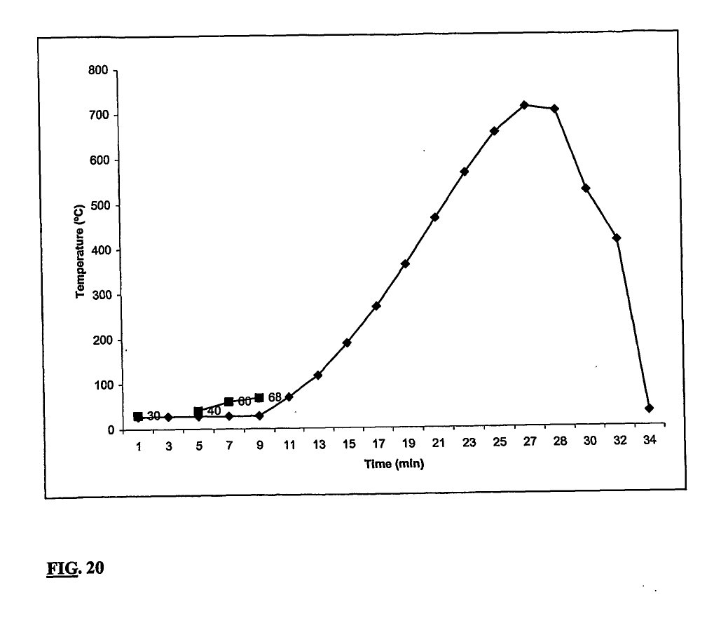

The thermal schedule represented in Table VI shows that the schedule included a pre-heating period of fifteen minutes to evaporate the water in the layered restoration. Raising the microwave power level to 68% was sufficient to achieve a maximum sintering temperature of 700° C. with a dwell time of one minute, as shown in FIG. 20. The microwave switched off after the dwell period. The cooling rates were similar to prior schedules. The restorations were removed when the temperature was below 150° C.

TABLE VII
Thermal Schedule for Enameled Coping Microwave
Sintered at 700° C.

| Time (minutes) | Sintering Temperature (° C.) | Percentage Power |
|---|---|---|
| 1 | 27.1 | 30 |
| 3 | 27.6 | |
| 5 | 27.7 | 40 |
| 7 | 27.9 | 60 |
| 9 | 28.3 | 68 |
| 11 | 69.4 | |
| 13 | 116.8 | |
| 15 | 187.8 | |
| 17 | 268 | |
| 19 | 361.6 | |
| 21 | 465.4 | |
| 23 | 566.4 | |
| 25 | 655.2 | |
| 27 | 712 | |
| 28 | 705 | |
| 30 to 45 minute | Cool down | |

The finished restoration, however, did not have a good finish and had porous appearance compared to the sample fired with the 800° C. firing schedule shown in Table VI.

Microwave Sintering with Rapid Power Increase:

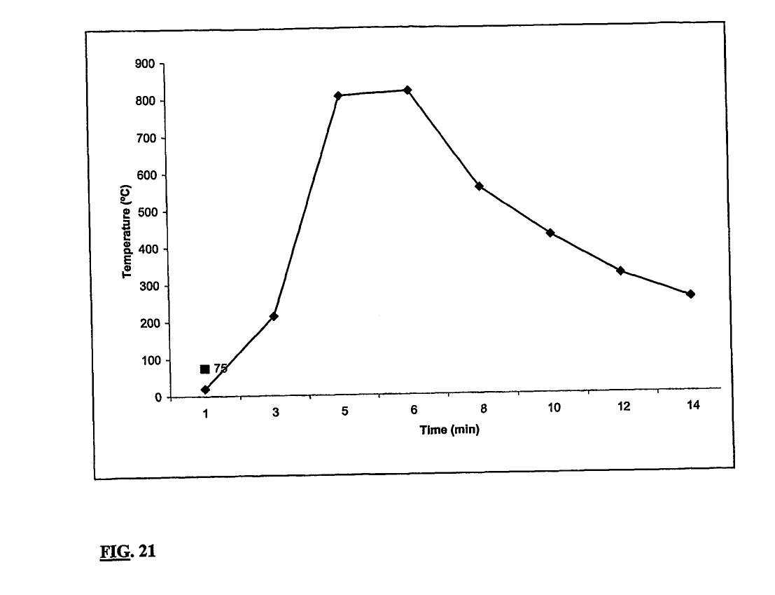

In this run, the maximum power was set to 75%, and no preheat period was provided before the sample was sintered at 800° C. The sintering temperature was achieved within five minutes using a heating ramp rate of more than 275° C. per minute. The cooling rate was of 100° C. per minute, as shown in FIG. 21.

The samples exhibited improper sintering with very rough, cloudy surfaces. This result is attributed to temperature being raised too quickly, that is, before the ceramic layers vitrified, such that complete sintering could not be accomplished.

Microwave Sintering with No Dwell Period:

Dwell periods of two to three minutes in conventional sintering are required to allow complete thermochemical reactions to take place. The possibility of completing these thermochemical reactions without any dwell periods was examined.

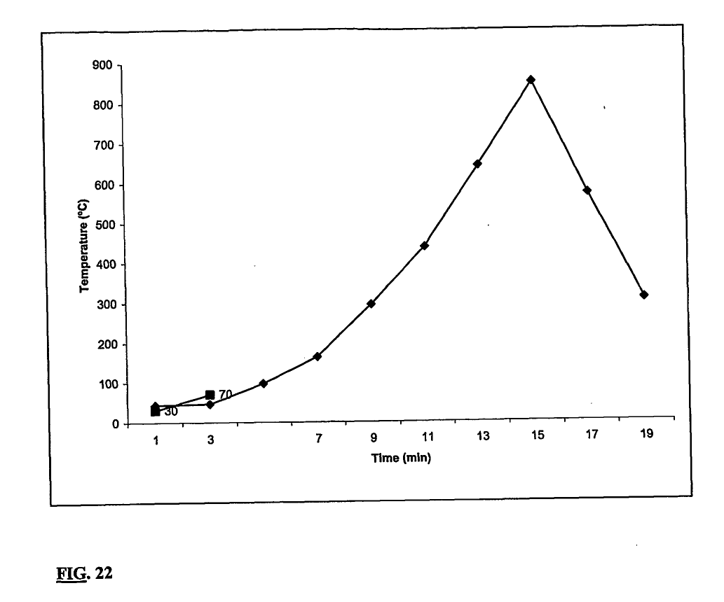

After the initial pre-heat period, the ramp rate was increased to 100° C. per minute until the sintering temperature was achieved, as shown in FIG. 22. The cooling rates were similar to the heating rates.

Upon examination, the sample exhibited complete sintering in patches. Areas near the margins of the sample were porous (cloudy), but the occlusal surface of the sample appeared to have a good translucency. Based on this, dwell periods are preferred to provide complete vitrification.

The remaining two samples were sintered with the preferred sintering profile as described by Table VI, with a dwell of one minute. The overall aesthetic results were excellent.

The above-described experiments with the six anterior teeth supplied by Town & Country Dental Laboratory were utilized to establish the microwave sintering parameters. The preferred temperature-power profile shown in Table VI, which resulted in complete sintering of restorations that were individually fired, was identified based upon information gained from these runs. It should be noted, however, that any new sintering technology related to dental crowns should have the capability to accommodate a plurality of crowns or restorations simultaneously. This feature is currently not available using conventional sintering methods.

Microwave Sintering of Multiple Crowns:

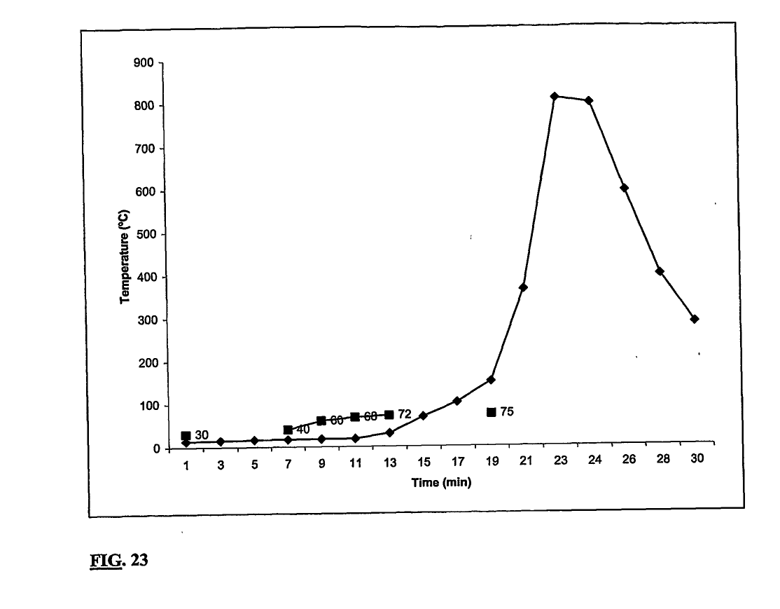

The copings obtained from Nobel Biocare Inc. (Yorba Linda, Calif.) were used in multiple crown microwave sintering experiments. Eight copings were enameled with layers of dental glass-ceramic as described above. The crowns were positioned on the reticulated zirconia floor of the thermal containment box in a horseshoe arrangement surrounding the thermocouple. Due to the large number of samples, the preheat period was raised to around twenty minutes as shown in the thermal schedule in Table VIII. The power was increased to 75% after the initial preheat period was completed because the larger sample load required more power. The maximum sintering temperature was around 810° C., and over a period of twenty seconds, the temperature dropped to 798° C. The power for the microwave furnace was switched off after the one-minute dwell period. The sintering process was completed in a period of thirty minute as shown in FIG. 23.

Each of the restoration samples was completely sintered and had excellent translucency. This confirmed the practical applicability of microwave sintering to produce sinter many crowns at once with a gradual thermal profile.

TABLE VIII
Thermal Profile for Simultaneously Sintering Multiple Samples

| Time (minutes) | Temperature (° C.) | Percentage Power |
|---|---|---|
| 1 | 13.7 | 30 |
| 3 | 15.2 | |
| 5 | 16.4 | |
| 7 | 17.2 | 40 |
| 9 | 17.7 | 60 |
| 11 | 18.2 | 68 |
| 13 | 30.7 | 72 |
| 15 | 68.7 | |
| 17 | 102.4 | |
| 19 | 151.2 | 75 |
| 21 | 365 | |
| 23 | 810 | |
| 24 | 798 | |
| 26 | 593.6 | |
| 28 | 398 | |

Post-Sintering Measurements:

Microscopic Examination:

samples that were sintered according to the power-temperature profiles shown in Tables V and VIII, including one microwave-sintered sample that was subjected to rapid bursts of power, were each sputter coated with gold-palladium prior to examination under the scanning electron microscope. A PHILIPS electron microscope was used to examine the surfaces of the samples and areas of interest were recorded.

Microstructural Results:

Examination of the microstructure of the samples shows that controlled crystallization of the glass results in the formation of tiny crystals that are evenly distributed throughout the glass. The glass-ceramic is a multiphase solid containing a residual glassy phase with finely dispersed crystalline phase. The number of crystals, the size and the growth rate are regulated by the dwell periods of the sintering temperature. This explains the dwell periods of two to three minutes (sometimes even five) conventionally followed by the dental technicians.

Examination of the microstructure of the microwave-sintered sample fired with the preferred thermal profile shown in Table V showed that leucite crystals (KalSi₂O₆), wollastonite (CaSiO₃) and calcium aluminum silicate (CaAlSiO₃) were precipitated in the glassy matrix of the material (some elongated and some circular). These crystals were determined by X-ray Diffraction. Single crystal formation is typical of this type of microstructure. The formation of such a microstructure can be attributed to the actual sintering process. During the sintering process, controlled crystallization occurs, with nucleation and growth of internal crystals.

The crystals were dispersed in the glassy matrix, but are not evenly distributed. Also, the crystals exhibited twinning (under higher magnification), which is characteristic of the tetragonal form. This is considered to be the usual microstructure. If larger amounts of crystals are to be formed, dwell periods have to be increased from one to two minutes. The crystals are uniformly distributed throughout the glassy phase. The crystal size averaged 10-15 μm, which is considered normal because the smaller the crystals, the greater the strength of the material.

The scanning electron picture of the sample fired by rapid power revealed leucite crystals dispersed in an uneven glassy matrix. The glassy matrix did not have sufficient time to dissolve completely and resulted in an irregular matrix characterized by pits and craters. A few crystals can be seen protruding from the glassy matrix. Also, at higher magnification, few areas of cloudy formations were seen, which are considered to be the result of incomplete precipitation of crystals that were entrapped within the glassy matrix due to rapid sintering which did not allow sufficient time for complete precipitation.

The results of the microstructural examination confirmed the fact that microwave sintering results in the same mechanism of crystal formation from the glassy matrix. Needle-like appatite crystals exhibit good chemical durability, and are therefore ideal for dental materials.

Indentation Hardness:

The most important property to compare processing technologies for restorative materials is the property of hardness. Hardness is the measure of resistance to permanent surface indentation or penetration. The importance of hardness measurements in restorative dentistry is that it signifies the abrasiveness of a material to which the natural dentition will be subjected. Thus, the mechanical properties of the sintered teeth samples were evaluated using indentation tests involving both a spherical indenter (dynamic testing) and diamond shaped indenter (static indention).

Dynamic Hardness Measurements:

Brinell testing has been used extensively for determining the hardness of metals and metallic materials used in dentistry. In view of the significant elastic strain exhibited by brittle materials, however, Brinell testing is not recommended to determine the hardness of dental crowns. The American Dental Association recommends only Vickers hardness testing for dental crowns, dental cements or dental plastics, or those materials, which exhibit elastic recovery.

Only two samples were subjected to Brinell hardness testing, since this testing method is very technique sensitive and typically requires completely flat samples. A Brinell Dynamic hardness tester fitted with a 2 mm spherical indenter was used. The computer controls on the system recorded the data. A 200 g load was applied to indent the samples. As the indenter was forced into the sample, the change in the voltage over the load cell was converted to a load in grams. Thus, the dynamic recording micro-indenter permitted measurements of a load vs. penetration curve which was displayed by the Labview® software program.

Based on the maximum penetration depth (Hₘₐₓ), the maximum load (Pₘₐₓ), the diameter of the indenter (d) and the final penetration depth (H_{f}), the Dynamic Brinell Hardness was calculated as follows:
DBH=Pₘₐₓ/3.142×d×H_{f}.

Results of Dynamic Brinell Hardness Testing:

A load of 200 g was used for this testing. The maximum displacement was 19 μm and the final displacement after elastic recovery was around 11 μm. Based on the maximum displacement and the final penetration depth, the Dynamic Brinell hardness number was 31.3 MPa.

Static Hardness and Fracture Toughness Measurements:

For the indentation hardness testing, including the Brinell hardness testing and fracture toughness measurements, the samples were not polished, because the layers of the dental glass-ceramic ranged from 0.4-0.6 mm, and the removal of the outer “ceramming skin” has been shown to increase the strength of the glass-ceramic crown by removing flaws that are unique to layers on the ceramic. In most studies on dental ceramics reported in the literature, fracture toughness has been determined by the indentation technique. The experimental method followed requires small specimens and is fairly simple to perform. A load range greater than 4.9 N (500 g) could not be tested, however, since these loads produced excessive chipping and crack branching.

A Vickers micro-hardness indenter was used to measure the Vickers Indentation number and Indentation Fracture Toughness. Five samples were indented using a diamond indenter with maximum load of 200 g, and the indent was maintained for a period of ten seconds. Three samples were indented under a 500 g load that was maintained for a period of ten seconds. The indented surfaces were verified on a television monitor attached to the equipment. When a good indent was made, an image was produced using ImagePro software. The mean diagonal length and the crack length were measured using the software. The Vickers hardness number and the Indentation fracture toughness were calculated according to the formulae described above.

Static Hardness Results AT 200 Kg Load:

In dentistry, very little data exists for indentation hardness and indentation fracture toughness measurements at 200 g. Samples that were sintered alone with the preferred profile, samples that were sintered simultaneously with other samples, according to the preferred profile, samples sintered with rapid firing (improper sintering), and conventional tooth samples, were subjected to 200 g load testing. Indentation data were obtained from at least three specimens (eighteen indents) for the ideal microwave sintering profile, two specimens for the conventionally sintered sample (nine indents), and one tooth from the rapidly fired group (five indents).

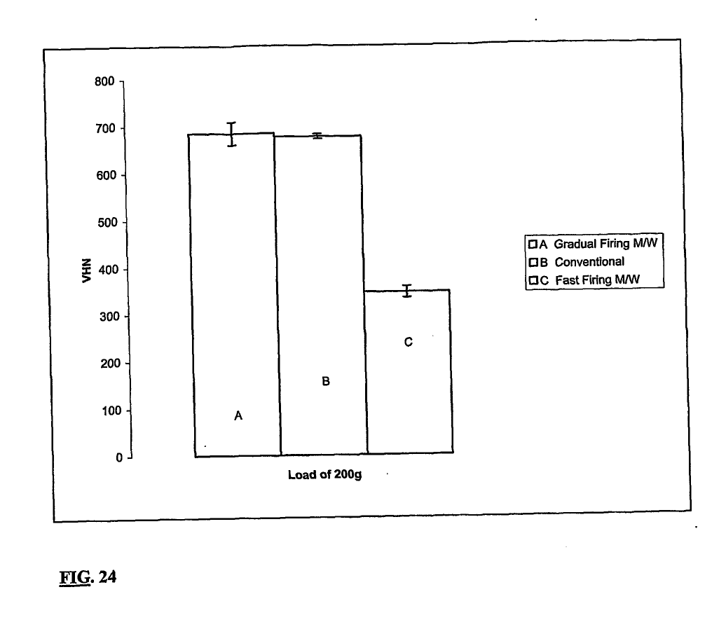

There was no considerable difference between the microwave-sintered samples fired under the preferred thermal profile and the conventionally sintered samples. FIG. 24 shows a comparison between the VHN values obtained for the conventionally fired samples and the microwave-sintered samples that were rapid fired and fired according to the preferred profile. The indentation hardness number is comparable with those published in the literature as shown in Table IX. The hardness values are much higher than that of the enamel. That may indicate that the opposing dentition may be subjected to more wear. This is the main disadvantage of leucite containing glass-ceramic.

Table IX. Hardness Values for Known Materials Compared to Microwave

TABLE IX
Hardness Values for Known Materials Compared to Microwave
Sintered Samples

| Materials | VHN (200 g load) ± S.D |
|---|---|
| Stainless Steel | 217.8 ± 7.8 |
| Human Enamel | 332.3 ± 9.5 |
| IPS Classic | 582 ± 16.3 |
| Steatite | 683.5 ± 30 |
| M/W Sintered with preferred profile | 685 ± 24.5 |
| M/W Rapid Firing | 345 ± 6 |

Static Hardness Results at 500 Kg Load:

Based on twelve indents made under a load of 500 g, the Vickers hardness number was calculated to be 6.56±0.4 GPa. This was in accordance with published values of other dental glass-ceramics as shown in Table X.

TABLE X
Comparisons of Hardness Values between Microwave Sintered
Samples and Published Data for Dental Samples

| Materials | VHN (500 g load) ± S.D. |
|---|---|
| C-1 | 5.71 ± 0.23 |
| V-B | 5.74 ± 0.11 |
| C-G | 5.64 ± 0.20 |
| E | 5.84 ± 0.20 |
| W-B | 5.54 ± 0.17 |
| L | 5.38 ± 0.15 |
| N | 5.93 ± 0.16 |
| V-O | 6.04 ± 0.22 |
| M | 5.33 ± 0.14 |
| VDN | 6.62 ± 0.58 |
| NBK | 6.66 ± 0.74 |
| M/W Sintered Sample | 6.56 ± 0.4 |

Static Indentation Fracture Toughness Results:

The indentation fracture toughness is an invaluable tool for studying the behavior and properties of brittle material because the crack growth parameter is identical to those cracks expected in clinical conditions. The loads of 200 g and 500 g introduced flaws of controlled size, shape and location that enabled direct measurements of the flaws. As a result of using the ImagePro software program to measure the flaw sizes, the obtained values are accurate. The indentation hardness and fracture toughness values obtained compare well with literature reported values. Significant differences between the hardness values obtained at low loads, and the hardness values obtained at high load were observed for the samples.

The indentation fracture toughness was measured from the radial cracks propagating from the corners of the indents. The indents made on the rapid fired microwave sample were not as sharp as those seen on the conventionally and the microwave-sintered sample fired at the preferred profile. Moreover, the cracks were difficult to identify under 200 g loads. The cracks were also straighter and longer, which suggests a different structure and even greater brittleness for this material.

FIG. 24 shows a comparison between the VHN values obtained for the conventionally fired samples and the microwave-sintered samples that were rapid fired and fired according to the preferred profile. The average fracture toughness value for the microwave-sintered samples that were fired according to the preferred profile was 2.26±0.08 MPa(m)^{0.5} and compared well with the conventionally sintered sample, which was 2.25 MPa(m)^{0.5}. The rapidly fired microwave sample displayed a lower fracture toughness of 0.6 MPa(m)^{0.5}, which was expected considering the porous sample surface.

It is also noteworthy that cracks were generated solely by the application of load, because no original surface cracks were observed. Some indents made at 200 g were often too light and the radial cracks were not well defined. The edges of the indents for the porcelain were not as sharp as those seen on the zirconia cylinders. This may be due to the high indent loads used and the sample preparation that resulted in well-defined indents. Yet, the small crack sizes correlate well with the fracture toughness property because it controls the materials response during processing, grinding, erosion and wear.

X-Ray Diffraction:

The dental glass-ceramic powders were analyzed using X-ray diffraction (XRD) to determine the crystalline phases present in the sample and to obtain the composition of the powders. XRD data was obtained with Cu-Kₐ radiation using a Siemens D500; a 40 kV accelerating potential, and a 30 mA current. A 2-theta angle scanning range was set for 10°-70°, with a step size of 0.04° and a dwell time of 10 seconds. The resultant spectral peaks were analyzed using the JADE computer program.

XRD data of the microwave-sintered samples was obtained using a Siemens (Kristalloflex 810) low angle reflectometer. A 2-theta angle scanning range was set for 10°-150°.

XRD Results:

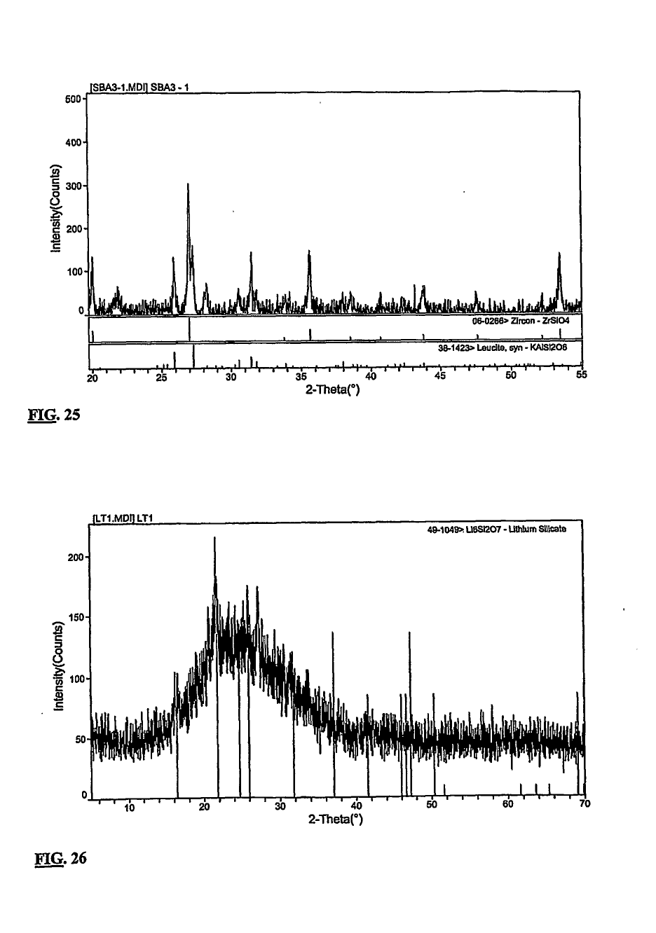

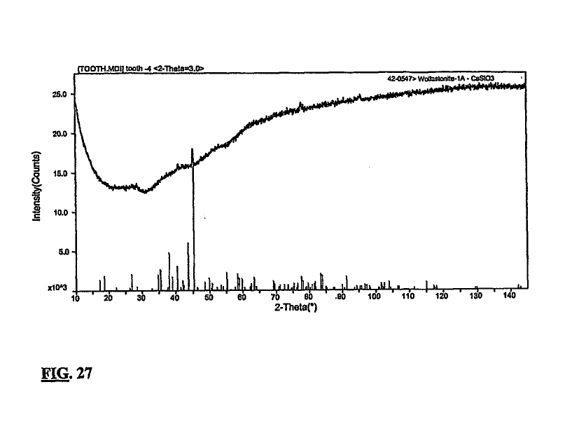

FIG. 25 shows the XRD pattern obtained for the opaque base glass-ceramic sample. The XRD patterns matched well with the PDF #06-0266 and #38-1423 indicating that the glass-ceramic is probably analogous to a Leucite and Zircon tetragonal phase. The leucite is the main crystalline phase that also imparts strength and precipitates as needle-like crystals from the glassy matrix. It also lends chemical stability to the restoration and prevents the restorations from attacks by oral fluids, which can dissolve restorations. The addition of the pigmenting oxide, zircon is added to achieve opacity. FIG. 26 depicts the XRD of the luster shade of the glass-ceramic. Lithium silicate was identified as the main phase present in the luster shade that corresponded with the PDF #49-1049.

XRD analysis of the sintered coated coping samples identified the presence of a leucite phase, wollastonite and calcium aluminum silicate (CaAlSiO₃). The trace amount of various phases was difficult to model due to low levels and broad peak shapes. FIG. 27 shows the XRD pattern.

Flexural Strength Testing:

Important test parameters for determining the strength of brittle dental materials by flexural testing are the specimen thickness, the contact zone at loading, the homogeneity and porosity of the material, and the loading rate. ISO standards (ISO 6872, 1984) are used by many researchers and require a three-point or a four-point bending test for the evaluation of the modulus of rupture (MOR) of dental porcelains.

Dental crowns and prostheses are more complicated than beams, but the principles are same. Laminated all-ceramic prostheses are weak when compared to simple feldspathic prostheses when low strength feldspathic surfaces are subjected to tensile forces. Tensile failures of crowns made of zirconia layered with porcelain have been clinically observed.

Since actual modulus of rupture (MOR) testing could not be suitably performed on the actual sintered dental crowns, zirconia substrates coated with the same layers of dental glass-ceramics were used instead. Yttria stabilized zirconia substrates, obtained from Coors Tek (Golden, Colorado), measuring 10 cm (length) by 10 cm (width) by 0.71 mm (thickness) were used. These beams were then machined to 50 mm (length) by 4 mm (breadth)×0.71 by (thickness) with parallel edges. Next, layers of the dental ceramics, (shade base, dentine, enamel and the luster shades) were layered or enameled onto the zirconia substrates using the same methods described above for the enameled coping samples. The total thickness of the coating was 0.5-0.8 mm.

Twenty substrates were coated; ten designated for conventional sintering and ten designated for microwave sintering. The preferred firing schedule shown in Table V used for sintering the enameled coping samples was employed in microwave sintering these substrates. The power was increased as dictated by the temperature requirements.

The remaining ten samples were sintered in the conventional furnace. The specimens were re-fired to achieve a natural glaze. Thus, the layered beams were formed with layers of veneering porcelain and core materials. Four-point bend measurements were also performed on three uncoated zirconia substrates for result comparisons purposes. These beam samples were subjected to four-point bend testing as follows.

The specimens were loaded in a four-point bend test fixture (with the coated surface positioned in tensile direction) and tested on a universal testing machine (Instron Corp., Canton, Massachusetts, model 8532) with a crosshead speed of 0.5 mm per minute. Factors including dimension, span, load rate, and surface finish (glazed finish), which are known to affect the mean and distribution of strength values of dental porcelain, were standardized in this study. The flexure strength or the modulus of rupture was calculated as follows:
Flexure Strength (S)=3WI/2bd²

Where I=the distance between the supports; b=width of the specimens;

d=the depth or thickness of the specimen; and

W=the maximal load before fracture.

### Flexural Strength Results

### Microwave and Conventionally Sintered Beams

The beams which had the weakest material (Noritake dental glass-ceramic) on the tensile surface and the strongest material (zirconia) on the compressive surface tended to undergo failure initially on their tensile surfaces, and then undergo partial de-lamination prior to a secondary failure of the stronger zirconia substrate. This type of failure occurred in all microwave-sintered samples.

The conventionally sintered beam samples exhibited porosity, insufficient coating thickness and delamination during the testing. Thus, the data was not included in this comparative study. The modulus of rupture values obtained of the microwave-sintered beams were compared with known, published MOR values for conventionally sintered beams.

The reference ceramic materials used were ICZ (Inceram Zirconia), IC (Inceram Alumina), and ICS (Inceram Magnesium Aluminum Spinel). The modulus of rupture (MOR) for the uncoated beams were strongest, 2659±413 MPa (n=3), compared to the microwave-sintered, layered beams, which had MOR values of 632±105 MPa (n=6).

The drift in the values may be attributed to the weak interfacial bond strength between the layers of the glass-ceramic and the substrate that delaminated and caused early failure. Moreover, the exact processing history of the zirconia substrates was not known. The specimen thickness was very detrimental for the flexure strength values as depicted in Table XI, and the MOR was inversely proportional to the square of the specimen thickness, which resulted in higher values for the core. Nevertheless, the mean flexure strength values of the microwave-sintered materials are comparable with the flexure results of other researchers.

TABLE XI
Modulus of Rupture for the Core Substrate and the Coated
Substrates

| | Specimen Thickness | | |
|---|---|---|---|
| Sample | (mm) | Failure Load (N) | M.O.R. (MPa) |
| Substrate | 0.72 | 75 ± 12 | 2659 ± 413 |
| Substrate + | 1.61 ± 0.134 | 81.8 ± 17.7 | 632 ± 105 |
| Coating | | | |

The experiments detailed above show that microwave-sintered samples that were processed in a MHH system according to the present invention and by the methods according to the present invention exhibit properties that are comparable to, if not superior to, those of conventionally fired stabilized zirconia copings and coated zirconia crowns. Moreover, the sintering times achieved using the MHM system and the methods according to the present invention represent a fraction of the sintering times required for conventional sintering systems and processes.

While the present invention has been particularly shown and described with reference to the preferred mode as illustrated in the drawings, it will be understood by one skilled in the art that various changes in detail may be effected therein without departing from the spirit and scope of the invention as defined by the claims.

We claim:

1. A method for sintering ceramic materials at a sintering temperature greater than room temperature using a microwave hybrid heating system, said method comprising the steps of:
(a) providing a ceramic member to be sintered, said ceramic member comprising a material that does not substantially reflect microwave energy and that does not substantially couple to microwave energy until said ceramic material is heated to a microwave coupling-trigger temperature;
(b) providing a microwave furnace having a magnetron microwave source and a microwave chamber lined with a reflective material;
(c) providing a thermal containment box having an inner surface and an outer surface defining a thermal containment chamber, said thermal containment box comprising an insulative material that does not substantially absorb or reflect microwave energy at any temperature less than or equal to a maximum sintering temperature of said ceramic member to be sintered and which has a melting temperature that is greater than said maximum sintering temperature of said ceramic member to be sintered;
(d) providing at least one susceptor within said thermal containment chamber, said at least one susceptor comprising a material that directly couples to microwave energy at room temperature substantially immediately;
(e) positioning said ceramic member within said thermal containment chamber proximate said at least one susceptor;
(f) irradiating said microwave chamber with microwave energy from said magnetron source, whereby said at least one susceptor substantially immediately couples to the microwave energy and the heat from said at least one susceptor radiates therefrom to heat said thermal containment chamber and said ceramic member positioned therewithin such that the temperature of said ceramic member increases to said microwave coupling-trigger temperature, at which time said ceramic member couples directly to the microwave energy; and
(g) sintering said ceramic member with the microwave energy in cooperation with the radiant energy from said at least one susceptor.

2. The method of claim 1, wherein said at least one susceptor has a microwave reflecting temperature that is greater than or substantially equal to said microwave coupling-trigger temperature of said ceramic member.

3. The method of claim 1, wherein said at least one susceptor comprises at least one primary susceptor and at least one secondary susceptor.

4. The method of claim 3, wherein said at least one primary susceptor has a microwave reflecting temperature that is less than or substantially equal to said coupling temperature of said ceramic member.

5. The method of claim 4, wherein said at least one secondary susceptor has a microwave coupling-trigger temperature that is higher than room temperature and lower than said microwave reflecting temperature of said at least one primary susceptor.

6. The method of claim 3, wherein said at least one primary susceptor and said at least one secondary susceptor each have a melting temperature that is greater than a maximum sintering temperature of said ceramic member.

7. The method of claim 1, wherein said at least one susceptor comprises SiC and said ceramic member comprises zirconia stabilized with about 3 mol % yttria.

8. The method of claim 3, wherein said at least one primary susceptor comprises SiC and said at least one secondary susceptor comprises a zirconia ceramic.

9. The method of claim 1, wherein said at least one ceramic member comprises a green dental ceramic material.

10. The method of claim 1, wherein said at least one ceramic member comprises a sintered dental ceramic material that is coated with one or more layers of a dental enamel material or a glass-ceramic material.

11. The method of claim 9, wherein said green dental ceramic material is Y-TZP.

12. The method of claim 10, wherein said sintered dental ceramic material is Y-TZP.

13. A microwave hybrid heating system for sintering at least one ceramic member having a microwave coupling-trigger temperature greater than room temperature, said microwave hybrid heating system comprising:
a microwave furnace having a magnetron microwave source and a microwave chamber lined with a reflective material;
a thermal containment box having an inner surface and an outer surface defining a thermal containment chamber, said thermal containment box comprising an insulative material that does not substantially absorb or reflect microwave energy at any temperature less than a maximum sintering temperature of said at least one ceramic member to be sintered and which has a melting temperature greater than said maximum sintering temperature of said at least one ceramic member to be sintered; and
at least one susceptor provided within said thermal containment chamber, said at least one susceptor comprising a material that directly couples to microwave energy at room temperature substantially immediately;
wherein said at least one ceramic member to be sintered is positioned within said thermal containment chamber such that when microwave energy from said magnetron source irradiates said thermal containment box, said at least one susceptor substantially immediately couples to the microwave energy, heat generated from said at least one susceptor radiates therefrom to heat said thermal containment chamber and said at least one ceramic member positioned therein such that the temperature of said at least one ceramic member increases to said microwave coupling-trigger temperature, at which time said at least one ceramic member couples directly to the microwave energy and is sintered by the microwave energy in cooperation with the radiant heat emitted from said at least one susceptor.

14. The microwave hybrid heating system of claim 13, wherein said at least one susceptor has a microwave reflecting temperature greater than or substantially equal to said microwave coupling-trigger temperature of said at least one ceramic member.

15. The microwave hybrid heating system of claim 13, wherein said at least one susceptor comprises at least one primary susceptor and at least one secondary susceptor.

16. The microwave hybrid heating system of claim 15, wherein said at least one primary susceptor has a microwave reflecting temperature less than or substantially equal to said microwave coupling-trigger temperature of said at least one ceramic member.

17. The microwave hybrid heating system of claim 16, wherein said at least one secondary susceptor has a couple triggering temperature that is higher than room temperature and lower than said microwave reflecting temperature of said at least one primary susceptor.

18. The microwave hybrid heating system of claim 15, wherein said at least one primary susceptor and said at least one secondary susceptor each have a melting temperature that is greater than a maximum sintering temperature of said at least one ceramic member.

19. The microwave hybrid heating system of claim 13, wherein said at least one susceptor comprises SiC and said ceramic member comprises zirconia stabilized with about 3 mol % yttria.

20. The microwave hybrid heating system of claim 15, wherein said at least one primary susceptor comprises SiC and said at least one secondary susceptor comprises a zirconia ceramic.
